(19) United States
(12) Patent Application Publication
(10) Pub. No.: US 2008/0305417 A1
(43) Pub. Date: Dec. 11, 2008

(54) MONOLAYER TYPE ELECTROPHOTOGRAPHIC PHOTORECEPTOR AND ELECTROPHOTOGRAPHIC DEVICE PROVIDED WITH THE SAME

(76) Inventors: Hiroshi Sugimura, Osaka (JP); Akihiro Kondoh, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/117,365

(22) Filed: May 8, 2008

(30) Foreign Application Priority Data
Jun. 6, 2007 (JP) 2007-150524

(51) Int. Cl. G03C 1/73; G03G 15/00

(52) U.S. Cl. 430/58.85; 399/159

(57) ABSTRACT

a monolayer type photoreceptor obtained by laminating a monolayer type photosensitive layer containing a charge generation material and a charge transport material on a conductive support, wherein the above monolayer type photosensitive layer comprises, as the above charge transport material; a hole transport material represented by the following formula (1) and an electron transport material represented by the following formula (2)

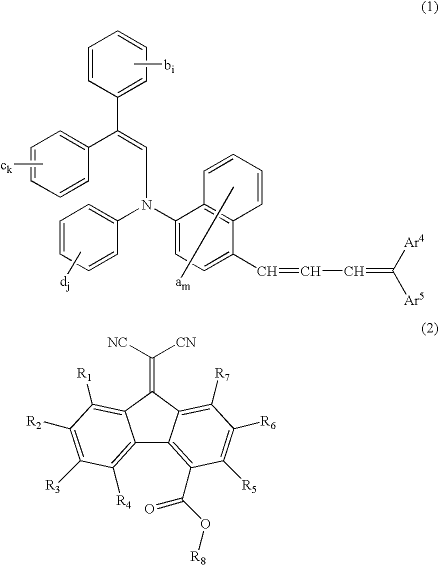

### CROSS-REFERENCE TO RELATED APPLICATIONS

This application is related to Japanese Patent Application No. 2007-150524 filed on Jun. 6, 2007 whose priority is claimed under 35 USC § 119, the disclosure of which is incorporated by reference in its entirety.

### BACKGROUND OF THE INVENTION

1. Field of the Invention

The present invention relates to an electrophotographic photoreceptor used in the formation of an image in the electrophotographic system and to an electrophotographic device provided with the electrophotographic photoreceptor.

2. Description of the Related Art

Many electrophotographic system image formation devices (hereinafter also referred to as “electrophotographic device”) utilizing electrophotographic technologies to form an image are used for copying machines, printers, facsimile machines and the like.

In electrophotographic devices, an image is formed through an electrophotographic processes mentioned below. First, a photosensitive layer of the electrophotographic photoreceptor (hereinafter also called “photoreceptor”) provided in the devices is charged uniformly to a prescribed potential by a charger and then exposed to light such as laser light emitted corresponding image information from an exposure means to form an electrostatic latent image. Then, a developer is supplied from a developing means to the formed electrostatic latent image to stick colored microparticles called a toner which is a developer component to the surface of the photoreceptor, thereby developing the electrostatic latent image to visualize the electrostatic image as a toner image. Then, the formed toner image is transferred to a transfer receiving material such as recording paper from the surface of the photoreceptor by a transfer means and fixed to the transfer receiving material to form a desired image on the transfer receiving material.

In the transfer operation using the transfer means, toners on the surface of the photoreceptor are not all transferred and shifted to the recording paper but partly remain on the surface of the photoreceptor. Also, there is the case where a paper powder of the recording paper remains stuck to the surface of the photoreceptor. Also, foreign substances such as residual toners and stuck paper powder on the surface of the photoreceptor like this exert an adverse influence on the quality of the formed image, and are therefore removed by a cleaning device. Also, an improvement has been recently made in technologies concerning a cleaner-less system, in which residual toners are recovered (or removed) by a cleaning function (cleaning system doubling as a developer to be added to a developing means) without using an independent cleaning means. After the surface of the photoreceptor is cleaned in this manner, charges on the surface of a photosensitive layer are removed by a charge remover or the like to extinguish the electrostatic latent image.

Such a photoreceptor used in the electrophotographic process has a structure in which a photosensitive layer containing a photoconductive material is laminated on a conductive substrate.

As the photoreceptor currently used, an electrophotographic photoreceptor (hereinafter, referred to as “inorganic type photoreceptor”) provided with a photosensitive layer containing an inorganic type photoconductive material as its major component is widely used. Typical examples of the inorganic type photoreceptor include selenium type photoreceptors using a layer constituted of amorphous selenium (a-Se) or amorphous selenium arsenic (a-AsSe) as the photosensitive layer; zinc oxide type photoreceptors or cadmium sulfide type photoreceptors using, as the photosensitive layer, a material obtained by dispersing zinc oxide (ZnO) or cadmium sulfide (CdS) together with sensitizers such as dyes in a resin; and amorphous silicon type photoreceptors (a-Si photoreceptors) using a layer containing amorphous silicon (a-Si) as the photosensitive layer.

However, the inorganic type photoreceptors have the following drawbacks.

The selenium and cadmium type photoreceptors have problems concerning heat resistance and storage stability and are also toxic to human bodies and environments. It is therefore necessary to recover and to properly dispose of photoreceptors using these metals after they are used.

The zinc oxide type photoreceptors have the drawback that they are deteriorated in sensitivity and durability and are therefore almost not used at present.

The a-Si photoreceptors attracts remarkable attention as pollution-free inorganic type photoreceptors and have the advantage that they have high sensitivity and durability but, on the contrary, have the disadvantage that they have difficulties in forming the photosensitive layer uniformly, easily generate image defects, are reduced in productivity and have high production costs because they are produced by a plasma chemical vapor growth method.

Because these inorganic type photoreceptors have many drawbacks and photoreceptors (hereinafter also referred to as “organic type photoreceptor”) using an organic photoconductive material, that is, an organic photoconductor (abbreviation: OPC) have been studied and developed and have come to be a leading photoreceptor.

Though these organic type photoreceptors have some problems concerning sensitivity, durability and stability to the circumstance, they have larger merits than inorganic type photoreceptors in view of toxicity, production cost and degree of freedom of material designs. For example, the organic type photoreceptors can be formed using easy and inexpensive methods typified by the dip coating method.

As the structure of such an organic type photoreceptor, various structures have been proposed, these structures including a monolayer structure in which a charge generation material and a charge transport material are both dispersed in a binder resin and formed on a conductive support, and a laminate structure or reverse double layer type structure in which a charge generation layer obtained by dispersing a charge generation material in a binder and a charge transport layer obtained by dispersing a charge transport material in a binder resin are formed in this order or reverse order on a conductive support. Among these structures, a functional separation type photoreceptor in which a charge transport layer is laminated on a charge generation layer as the photosensitive layer is superior in electrophotographic characteristics and durability. Therefore, the photoreceptor characteristics can be variously designed due to its high degree of freedom of material selection, and are hence widely put to practical use.

The organic type photoreceptors are classified into a negatively charged system in which the charge transport material which is a major functional component is a hole transport material and a positively charged system in which the charge transport material is an electron transport material.

Because the development of the hole transport materials having high charge transport ability preceded in the research and development of the organic type photoreceptors, the negatively charged system photoreceptors are put to practical use. However, this system has the problem that harmful ozone and nitrogen oxides generated much and it is therefore difficult to attain uniform charging by corona discharge.

On the other hand, the positively charged system is free from the above problems of the negatively charged system and also, process technologies used in the positively charged system inorganic type photoreceptors such as selenium type photoreceptors and a-Si photoreceptors can be applied to the positively charged system. Therefore, it has been desired to realize a positively charged system organic type photoreceptor having high performances.

As the positively charged system organic type photoreceptors which have been developed so far, there are a monolayer type photoreceptor (see U.S. Pat. No. 3,484,237) having a monolayer structure constituted of a charge transport complex of a polyvinylcarbazole (PVCz) and trinitrofluorenone (TNF), and a monolayer type photoreceptor obtained by dispersing a charge generation material and a hole transport material in a binder. Because the former photoreceptor has low sensitivity and also contains TNF which is a carcinogen and the latter photoreceptor has low sensitively, is reduced in charge retentive ability and is deteriorated in electric characteristics in repeated use, these photoreceptors are not used at present. Also, it is known that each charge mobility of electrons and holes is dropped by the formation of a charge transport complex in the monolayer type photoreceptor constituted of PVCz and TNF.

Also, in the publication of Japanese Examined Patent Publication No. 2718048, a diphenoquinone compound is disclosed as a charge transport material having an electron transfer function. The diphenoquinone compound has the drawback that it is less soluble in an organic solvent, has low affinity to a binder resin and tends to crystallize in the photoreceptor which is a cause of image defects in the output image.

In order to improve such a drawback, it is proposed to mix a diphenoquinone compound having a asymmetric structure and a benzoquinone derivative which is a low molecular material. However, the electron mobility of the photoreceptor is low and also, the problems of this photoreceptor concerning high residual potential caused by low efficiency in the injection of electrons from the charge generation material and the problems concerning a change or deterioration in fundamental electric characteristics such as sensitivity, charge retentive rate and residual potential by charge storage in repeated use have not been solved yet.

On the other hand, in the photoreceptor of electrophotographic devices, the above operations including charging, exposure, developing, transfer, cleaning and charge removing are practiced repeatedly. Therefore, it is demanded of the photoreceptor to have environmental stability, electric stability and high durability (printing durability) to mechanical external force in addition to high sensitivity and excellent photo-responsive ability. It is particularly demanded of the photoreceptor to have a surface layer resistant to scratching caused by cleaning members and the like.

Generally, the monolayer type photoreceptor has the problem that it is inferior in abrasive resistance to a laminate type only provided with a charge transport material existing on its surface side because a charge generation material which is a low molecular compound and a charge transport material are distributed on the entire surface layer.

Moreover, a monolayer type photoreceptor has been proposed which is not reduced in mobility when a charge transport complex is formed (see, the publication of Japanese Examined Patent Publication No. 3847732). Though this monolayer type photoreceptor is improved in electric characteristics, it has the problem that it has almost the same level of mechanical strength as the conventional products and its layer thickness is largely reduced in repeated use. When the amounts of the charge generation material and charge transport material are decreased to improve abrasive resistance, this impairs the electric characteristics of the monolayer type photoreceptor on the contrary.

There is a description concerning a monolayer type photoreceptor containing a compound corresponding to the formula (1) of the present invention in this patent application as the hole transport material and diphenoquinone as the electron transport material in the examinations of the publication of Japanese Unexamined Patent Publication No. 2004-151666. However, these materials form no charge transport complex and therefore, unlike the present invention of the patent application of this case, no improvement in electric characteristics is observed.

Also, in the publication of Japanese Examined Patent Publication No. 4-48215, a compound corresponding to the formula (2) of the present invention of the patent application is described as a component of the electron transport layer. However, these compounds have only electron transport ability and are therefore unsuitable to the monolayer type photoreceptor.

As mentioned above, the electric characteristics and mechanical durability in the photoreceptor can be attained at the same time with difficulty.

### SUMMARY OF THE INVENTION

According to a first aspect of the present invention, there is provided a monolayer type photoreceptor obtained by laminating a monolayer type photosensitive layer containing a charge generation material and a charge transport material on a conductive support, wherein the above monolayer type photosensitive layer comprises, as the above charge transport material;

a hole transport material represented by the following formula (1):

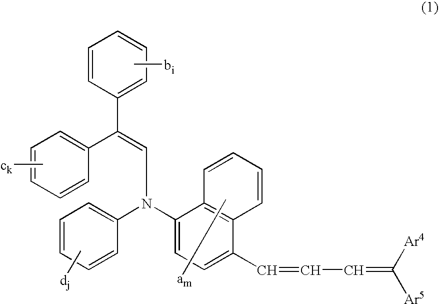

wherein:

“a” represents an alkyl group which may have a substituent, an alkoxy group which may have a substituent, a dialkylamino group which may have a substituent, an aryl group which may have a substituent, a halogen atom or a hydrogen atom;

m denotes an integer from 1 to 6, and when m is 2 or more, “a” may be the same or different and may be combined to form a cyclic structure;

b, c and d, which may be the same or different, respectively represent an alkyl group which may have a substituent, an alkoxy group which may have a substituent, a dialkylamino group which may have a substituent, an aryl group which may have a substituent, an aryloxy group which may have a substituent, an arylthio group which may have a substituent, a halogen atom or a hydrogen atom;

i, k and j, which may be the same or different, respectively denote an integer from 1 to 5, and when i is 2 or more, b may be the same or different and may be combined to form a cyclic structure, when k is 2 or more, c may be the same or different and may be combined to form a cyclic structure, and when j is 2 or more, d may be the same or different and may be combined to form a cyclic structure; and

Ar⁴ and Ar⁵, which may be the same or different, respectively represent an alkyl group which may have a substituent, an aryl group which may have a substituent, an arylalkyl group which may have a substituent, a heterocyclic group which may have a substituent or a hydrogen atom, provided that Ar⁴ and Ar⁵ are not hydrogen atoms at the same time and may be combined through an atom or atomic group to form a cyclic group; and

an electron transport material represented by the following formula (2):

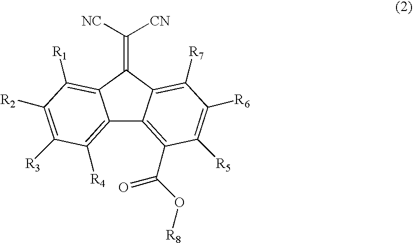

wherein R₁ to R₈, which may be the same or different, respectively represent an alkyl group which may have a substituent, an alkoxy group which may have a substituent, an aryl group which may have a substituent, a nitro group or a hydrogen atom.

According to a second aspect of the present invention, there is provided an electrophotographic device comprising the above monolayer type photoreceptor, a charge means that charges the above monolayer type photoreceptor, an exposure means that exposes the above charged monolayer type photoreceptor to light and a developing means that develops the electrostatic latent image formed by the above exposure.

### BRIEF DESCRIPTION OF THE DRAWINGS

FIG. 1 is a schematic cross-sectional view showing the structure of an essential part of a monolayer type photoreceptor according to the present invention;

FIG. 2 is a schematic cross-sectional view showing the structure of an essential part of a monolayer type photoreceptor according to the present invention; and

FIG. 3 is a schematic side view showing the structure of an electrophotographic device according to the present invention.

### DESCRIPTION OF THE PREFERRED EMBODIMENTS

The present invention is to provide a monolayer type photoreceptor which is superior in mechanical/electrical durability, is free from the generation of an abnormal image and has high durability in repeated use over a long period and to provide an electrophotographic device using the monolayer type photoreceptor.

The monolayer type photoreceptor of the present invention has a structure in which a monolayer type photosensitive layer containing a charge generation material and a charge transport material is laminated on a conductive support. The monolayer type photosensitive layer is characterized by that it contains a charge generation material, a hole transport material represented by the formula (1) and an electron transport material represented by the formula (2) as a charge transport material.

The monolayer type photoreceptor of the present invention has excellent printing durability, retains electrical stability when it is used for a long period of time, is free from the occurrence of deterioration of an image and is stable. The present invention can provide an electrophotographic device using the monolayer type photoreceptor. Also, the monolayer type photoreceptor of the present invention enables the production of a photoreceptor which is suitable to a positively charged system reduced in the generation of ozone.

The monolayer type photoreceptor of the present invention will be explained with reference to the drawings.

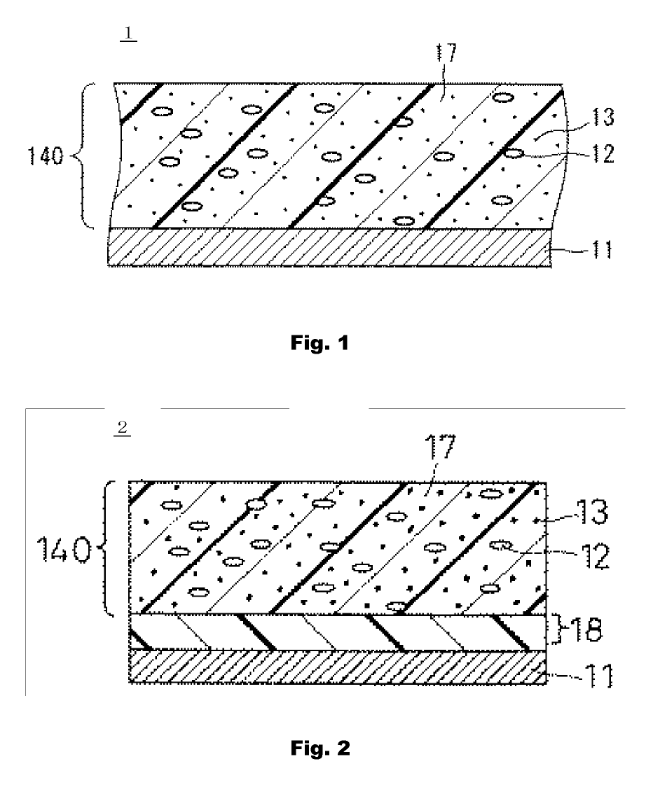

FIGS. 1 and 2 are respectively a schematic cross-sectional view showing the structure of an essential part of the monolayer type photoreceptor of the present invention.

A monolayer type photoreceptor 1 of FIG. 1 has a structure in which a monolayer type photosensitive layer 140 containing a charge generation material 12 and a charge transport material 13 is laminated on a conductive support 11.

A monolayer type photoreceptor 2 of FIG. 2 has a structure in which a monolayer type photosensitive layer 140 containing a charge generation material 12 and a charge transport material 13 is laminated on a conductive support 11 through an intermediate layer 18.

The symbol 17 indicates a binder resin.

### (Conductive Support 11)

No particular limitation is imposed on the structural material of the conductive support insofar as it has a function as the electrode of the monolayer type photoreceptor 140 and a function as a support member for the monolayer type photoreceptor 140 and it is used in the fields concerned.

Specific examples of the structural material include metal materials such as aluminum, aluminum alloys, copper, zinc, stainless steel and titanium; and materials obtained by laminating a metal foil on, applying a metal material to or forming a layer of a conductive compound such as a conductive polymer, tin oxide and indium oxide by vapor deposition or application on the surface of a base material such as hard paper or glass or polymer material such as polyethylene terephthalate, polyamide, polyester, polyoxymethylene, polystyrene.

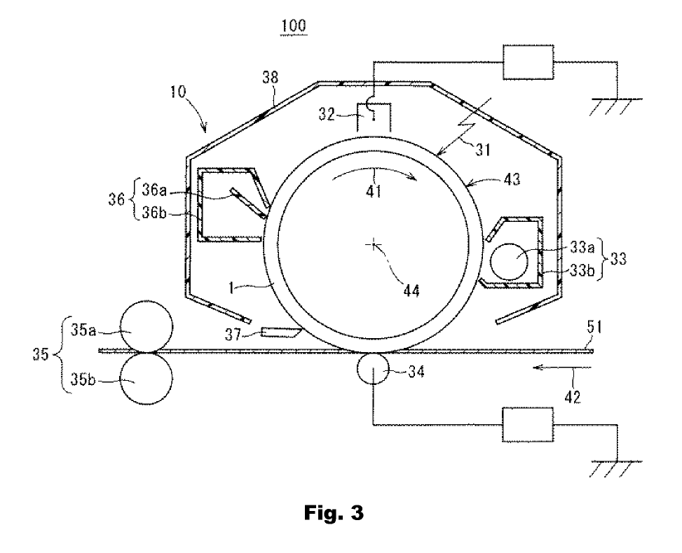

The shape of the conductive support is not limited to a sheet form as shown in FIGS. 1 and 2 and to a cylinder form as shown in FIG. 3 which will be explained later and may be a drum form, a column form or an endless belt form.

The surface of the conductive support 1 may be processed by anodic oxidation coating treatment, surface treatment using chemicals or hot water, coloring treatment or irregular reflection treatment such as surface roughing treatment according to the need to the extent that the image quality is not adversely affected.

The irregular reflection treatment is particularly effective when the photoreceptor of the present invention is used in an electrophotographic process using a laser as an exposure light source. Specifically, in the electrophotographic process using a laser as an exposure light source, the wavelengths of laser light are even. Therefore, there is the case where incident laser light interferes with the light reflected in the light-sensitive material, resulting in appearance of interference fringes on an image, causing image defects. In this respect, the above image defects caused by the interference of laser light having even wavelengths can be prevented by processing the surface of the conductive support by irregular reflection treatment.

### (Monolayer Type Photosensitive Layer 140)

The monolayer type photosensitive layer contains a charge generation material, a hole transport material represented by the formula (1) and an electron transport material represented by the formula (2) as a charge transport material, and a binder resin.

The charge generation material has the ability to absorb light, thereby generating charges.

As the charge generation material, compounds usually used in the fields concerned may be used.

Specific examples of the charge generation material include organic pigments or dyes such as azo type pigments (for example, monoazo type pigments, bisazo type pigments and trisazo type pigments), indigo type pigments (for example, indigo and thioindigo), perylene type pigments (for example, perylene imide and perylenic acid anhydride), polycyclic quinone type pigments (for example, anthraquinone and pyrene quinone), phthalocyanine type pigments (for example, metal phthalocyanine and X-type metal free phthalocyanine), squalilium dyes, pyrylium salts and thiopyrylium salts, triphenylmethane type dyes and inorganic materials such as selenium and amorphous silicon. These compounds may be either singly or in combinations of two or more.

Among these charge generation materials, phthalocyanine type pigments such as metal phthalocyanine and X-type metal free phthalocyanine are preferable and oxotitanium phthalocyanine represented by the formula (A) is more preferable.

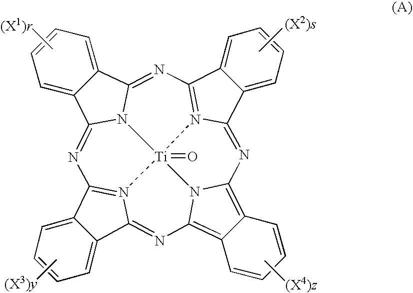

wherein X¹, X², X³ and X⁴, which may the same or different, respectively represent a hydrogen atom, a halogen atom, an alkyl group or an alkoxy group, and r, s, y and z, which may be the same or different, respectively denote an integer from 0 to 4.

Because the phthalocyanine type pigments have a high charge generation efficiency and charge injection efficiency, it absorbs light to generate a large number of charges and can inject the generated charges into the charge transport material contained in the monolayer type photosensitive layer without accumulating them therein, with smoothly carrying the injected charges in the charge transport material. Therefore, a photoreceptor having high sensitivity and high resolution can be obtained.

The charge generation material may be used in combination with sensitizing dyes.

Examples of these sensitizing dyes include triphenylmethane type dyes typified by Methyl Violet, Crystal Violet, Night Blue and Victoria Blue; acridine dyes typified by Erythrocin, Rhodamine B, Rhodamine 3R, Acridine Orange and Flapeocine; thiazine dyes typified by Methylene Blue and Methylene Green; oxazine dyes typified by Capri Blue and Meldola's Blue; cyanine dyes, styryl dyes, pyrylium salt dyes or thiopyrylium salt dyes.

The charge transport material has the ability to receive and transfer the charges generated in the charge generation material and includes a hole transport material and an electron transport material.

The hole transport material is represented by the formula (1).

The substituent in the formula (1) will be explained.

Examples of the alkyl group of the above “a” which may have a substituent include alkyl groups which may be substituted with an alkyl group having 1 to 4 carbon atoms, alkoxy group having 1 to 4 carbon atoms or halogen atom. Specific examples of the alkyl group include a methyl group, ethyl group, n-propyl group, isopropyl group, n-butyl group, isobutyl group, 1-methoxyethyl group, fluoromethyl group and trifluoromethyl group. Among these groups, a methyl group, isopropyl group or trifluoromethyl group is more preferable.

Examples of the alkoxy group of the above “a” which may have a substituent include alkoxy groups which may be substituted with an alkyl group having 1 to 4 carbon atoms, alkoxy group having 1 to 4 carbon atoms or halogen atom. Specific examples of the alkoxy group include a methoxy group, ethoxy group, n-propoxy group, isopropoxy group, n-butoxy group and isobutoxy group. Among these groups, a methoxy group is more preferable.

Examples of the dialkylamino group of the above “a” which may have a substituent include dialkylamino groups which may be substituted with an alkyl group having 1 to 4 carbon atoms, alkoxy group having 1 to 4 carbon atoms or halogen atom. Specific examples of the dialkylamino group include a dimethylamino group, diethylamino group and diisopropylamino group.

Examples of the aryl group of the above “a” which may have a substituent include aryl groups which may be substituted with an alkyl group having 1 to 4 carbon atoms, alkoxy group having 1 to 4 carbon atoms or halogen atom. Specific examples of the aryl group include a phenyl group, tolyl group, xylyl group, methoxyphenyl group, methylmethoxyphenyl group, 4-chlorophenyl group, 4-fluorophenyl group, naphthyl group and methoxynaphthyl group.

Examples of the halogen atom of the above “a” include a fluorine atom, chlorine atom, bromine atom and iodine atom. Among these groups, a fluorine atom is more preferable.

The alkyl group of the above b, c and d which may have a substituent has the same meanings as the above a and a methyl group is preferable.

The alkoxy group of the above b, c and d which may have a substituent has the same meanings as the above a and a methoxy group is preferable.

The dialkylamino group of the above b, c and d which may have a substituent has the same meanings as the above a and a dimethylamino group is preferable.

The aryl group of the above b, c and d which may have a substituent include aryl groups which may be substituted with an alkyl group having 1 to 4 carbon atoms, alkoxy group having 1 to 4 carbon atoms, an aryl group having 6 to 12 carbon atoms or halogen atom. Specific examples of the aryl group include a phenyl group, tolyl group, xylyl group, methoxyphenyl group, methylmethoxyphenyl group, 4-chlorophenyl group, 4-fluorophenyl group, biphenylyl group, naphthyl group and methoxynaphthyl group. Among these groups, a phenyl group and biphenylyl group are preferable.

Examples of the aryloxy group of the above b, c and d which may have a substituent include a 4-methylphenoxy group.

Examples of the arylthio group of the above b, c and d which may have a substituent include a phenylthio group.

The halogen atom of the above b, c and d has the same meaning as the above a.

The alkyl group of Ar⁴ and Ar⁵ which may have a substituent has the same meaning as the above a and a methyl group is preferable.

The alkyl group of Ar⁴ and Ar⁵ which may have a substituent include aryl groups which may be substituted with an alkyl group having 1 to 4 carbon atoms, alkoxy group having 1 to 4 carbon atoms, dialkylamino group having 2 to 6 carbon atoms or halogen atom.

Specific examples of the aryl group include a phenyl group, tolyl group, xylyl group, isopropylphenyl group, methoxyphenyl group, methylmethoxyphenyl group, t-butylphenyl group, 4-diethylaminophenyl group, 4-chlorophenyl group, 2-fluorophenyl group, 4-fluoroethylphenyl group, naphthyl group and methoxynaphthyl group. Among these groups, a phenyl group, tolyl group, methoxyphenyl group and naphthyl group are preferable.

Examples of the arylalkyl group of Ar⁴ and Ar⁵ which may have a substituent include a benzyl group.

Examples of the heterocyclic group of Ar⁴ and Ar⁵ which may have a substituent include a chromanyl group, thienyl group, 5-methylthienyl group and furyl group.

Specific examples of the hole transport material represented by the formula (1) are shown in Tables 1-1 to 1-21.

Among these compounds, the exemplified compounds 1, 3 and 6 and 111 are preferable.

These compounds may be synthesized by the method described in the publication of Japanese Unexamined Patent Publication No. 2004-151666.

TABLE 1-1

| No. | b | c | 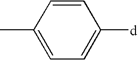 | 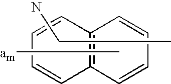 | Ar⁴ | Ar⁵ |
|---|---|---|---|---|---|---|
| 1 | H | H | 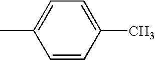 | 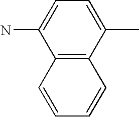 | H | 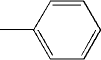 |
| 2 | H | H | 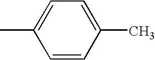 | 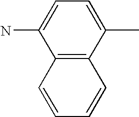 | H | 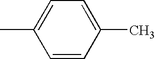 |
| 3 | H | H | 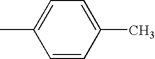 | 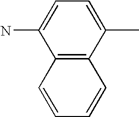 | —CH₃ | 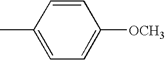 |
| 4 | H | H | 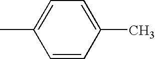 | 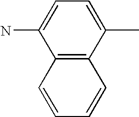 | H | 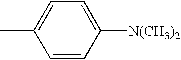 |
| 5 | H | H | 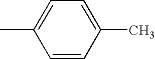 | 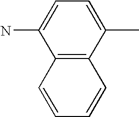 | H | 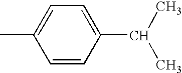 |
| 6 | H | H | 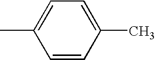 | 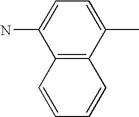 | H | 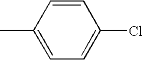 |
| 7 | H | H | 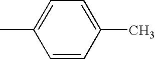 | 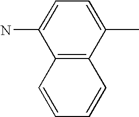 | —CH₃ | 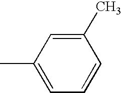 |

TABLE 1-2

| No. | b | c | 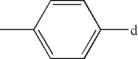 | 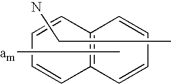 | Ar⁴ | Ar⁵ |
|---|---|---|---|---|---|---|
| 8 | H | H | 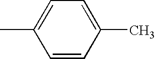 | 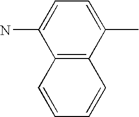 | H | 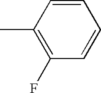 |
| 9 | H | H | 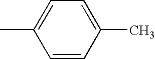 | 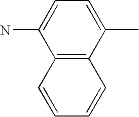 | —CH₃ | 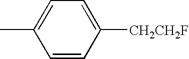 |
| 10 | H | H | 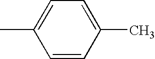 | 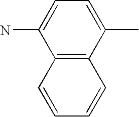 | —CH₃ | 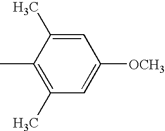 |
| 11 | H | H | 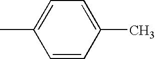 | 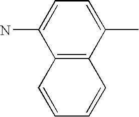 | H | 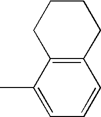 |
| 12 | H | H | 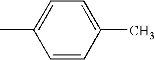 | 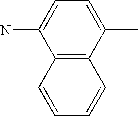 | H | 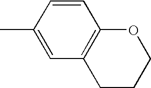 |
| 13 | H | H | 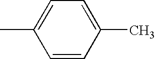 | 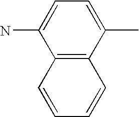 | H | 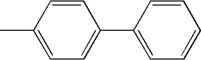 |
| 14 | H | H | 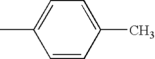 | 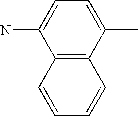 | H | 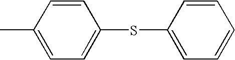 |

TABLE 1-3

| No. | b | c | 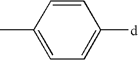 | 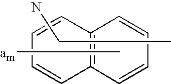 | Ar⁴ | Ar⁵ |
|---|---|---|---|---|---|---|
| 15 | H | H | 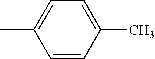 | 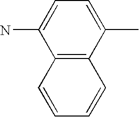 | H | 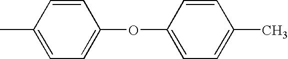 |
| 16 | H | H | 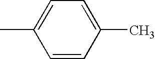 | 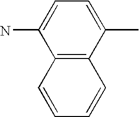 | —CH₃ | 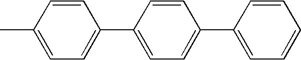 |
| 17 | H | H | 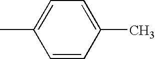 | 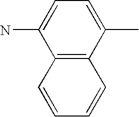 | H | 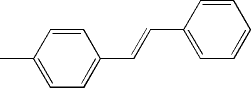 |
| 18 | H | H | 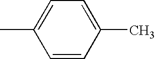 | 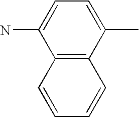 | —CH₃ | 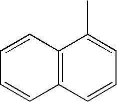 |
| 19 | H | H | 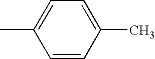 | 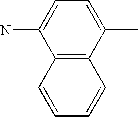 | H | 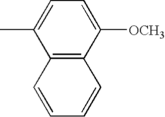 |
| 20 | H | H | 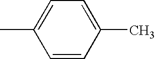 | 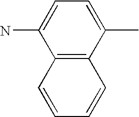 | H | 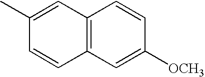 |
| 21 | H | H | 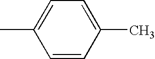 | 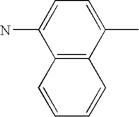 | H | 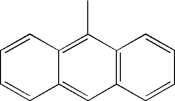 |

TABLE 1-4

| No. | b | c | 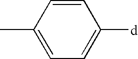 | 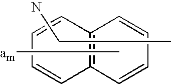 | Ar⁴ | Ar⁵ |
|---|---|---|---|---|---|---|
| 22 | H | H | 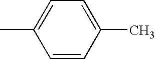 | 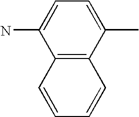 | H | 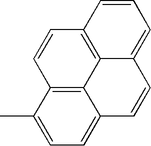 |
| 23 | H | H | 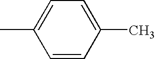 | 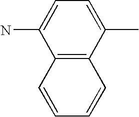 | —CH₃ | 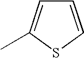 |
| 24 | H | H | 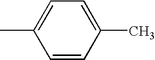 | 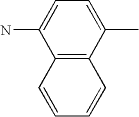 | —CH₃ | 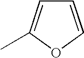 |
| 25 | H | H | 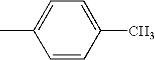 | 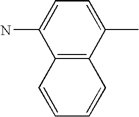 | H | 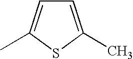 |
| 26 | H | H | 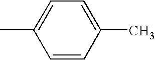 | 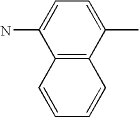 | H | 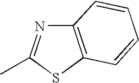 |
| 27 | H | H | 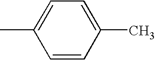 | 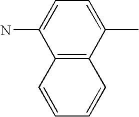 | H | 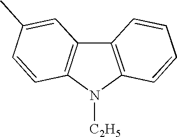 |
| 28 | H | H | 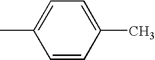 | 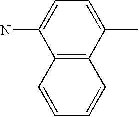 | 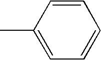 | 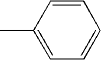 |

TABLE 1-5

| No. | b | c | 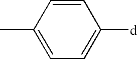 | 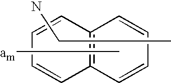 | Ar⁴ | Ar⁵ |
|---|---|---|---|---|---|---|
| 29 | H | H | 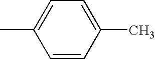 | 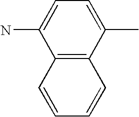 | 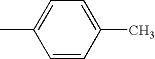 | 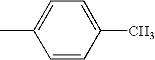 |
| 30 | H | H | 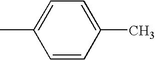 | 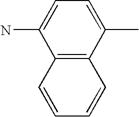 | 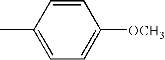 | 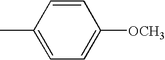 |
| 31 | H | H | 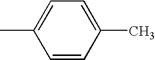 | 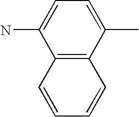 | 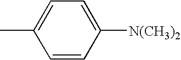 | 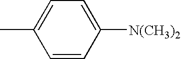 |
| 32 | H | H | 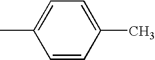 | 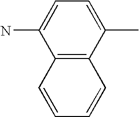 | 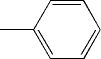 | 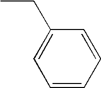 |
| 33 | H | H | 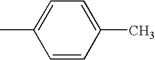 | 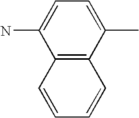 | 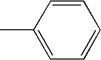 | 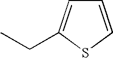 |

| | | | | | |
|---|---|---|---|---|---|
| 34 | H | H | 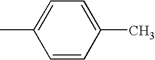 | 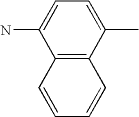 | 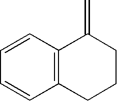 |
| 35 | H | H | 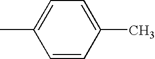 | 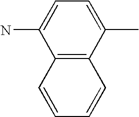 | 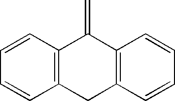 |

TABLE 1-6

| No. | b | c | 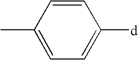 | 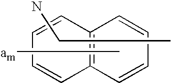 | Ar⁴ | Ar⁵ |
|---|---|---|---|---|---|---|
| 36 | H | H | 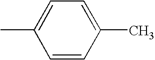 | 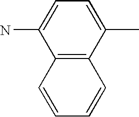 | 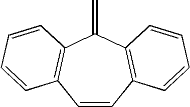 | |
| 37 | H | H | 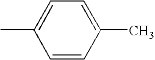 | 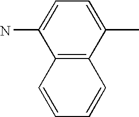 | 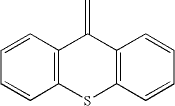 | |
| 38 | H | H | 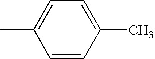 | 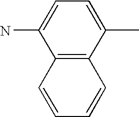 | 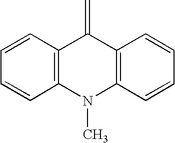 | |
| 39 | H | H | 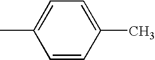 | 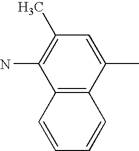 | H | 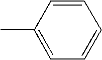 |
| 40 | H | H | 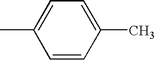 | 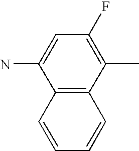 | H | 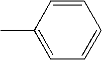 |
| 41 | H | H | 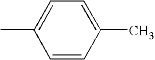 | 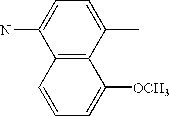 | H | 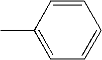 |
| 42 | H | H | 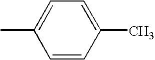 | 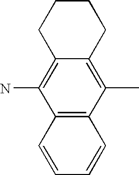 | H | 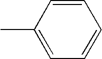 |

TABLE 1-7

| No. | b | c | 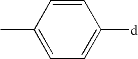 | 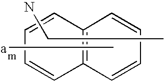 | Ar⁴ | Ar⁵ |
|---|---|---|---|---|---|---|
| 43 | H | H | 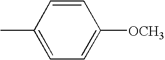 | 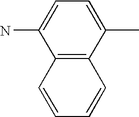 | H | 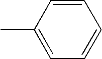 |
| 44 | H | H | 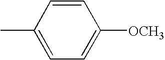 | 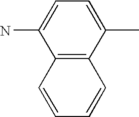 | H | 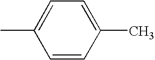 |
| 45 | H | H | 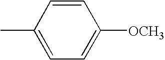 | 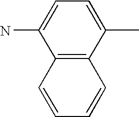 | —CH₃ | 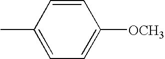 |
| 46 | H | H | 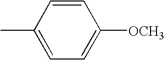 | 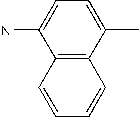 | H | 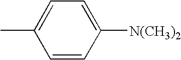 |
| 47 | H | H | 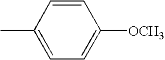 | 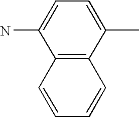 | H | 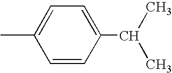 |
| 48 | H | H | 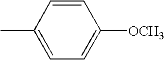 | 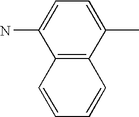 | —CH₃ | 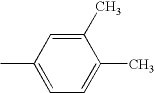 |
| 49 | H | H | 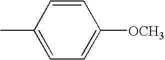 | 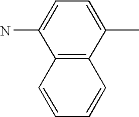 | H | 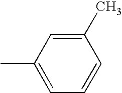 |

TABLE 1-8

| No. | b | c | 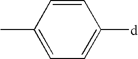 | 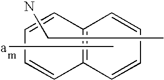 | Ar⁴ | Ar⁵ |
|---|---|---|---|---|---|---|
| 50 | H | H | 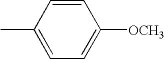 | 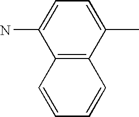 | H | 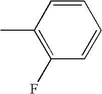 |
| 51 | H | H | 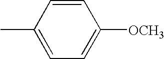 | 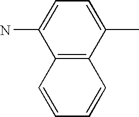 | H | 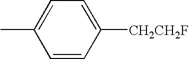 |
| 52 | H | H | 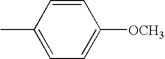 | 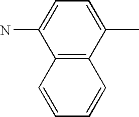 | H | 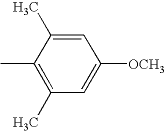 |
| 53 | H | H | 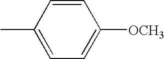 | 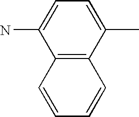 | H | 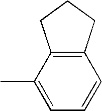 |
| 54 | H | H | 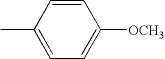 | 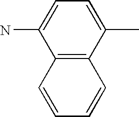 | H | 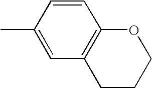 |
| 55 | H | H | 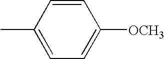 | 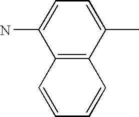 | H | 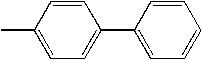 |
| 56 | H | H | 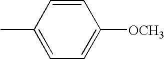 | 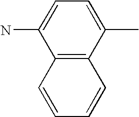 | H | 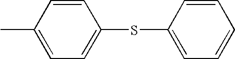 |

TABLE 1-9

| No. | b | c | 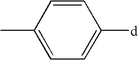 | 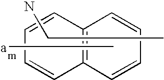 | Ar⁴ | Ar⁵ |
|---|---|---|---|---|---|---|
| 57 | H | H | 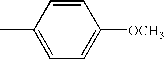 | 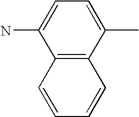 | H | 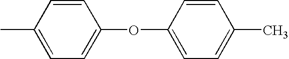 |
| 58 | H | H | 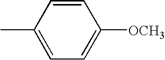 | 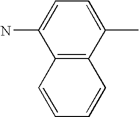 | H | 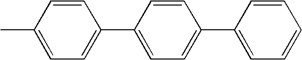 |
| 59 | H | H | 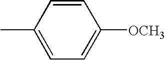 | 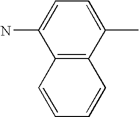 | H | 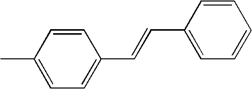 |
| 60 | H | H | 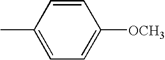 | 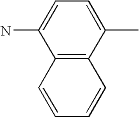 | H | 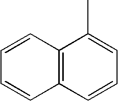 |
| 61 | H | H | 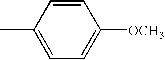 | 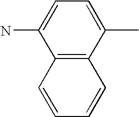 | H | 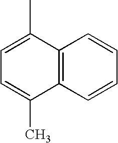 |
| 62 | H | H | 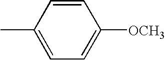 | 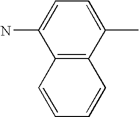 | H | 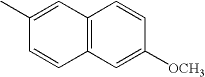 |
| 63 | H | H | 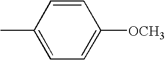 | 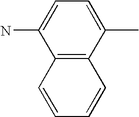 | H | 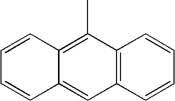 |

TABLE 1-10

| No. | b | c | 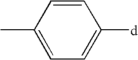 | 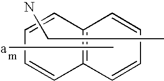 | Ar⁴ | Ar⁵ |
|---|---|---|---|---|---|---|
| 64 | H | H | 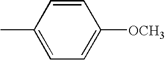 | 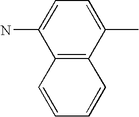 | H | 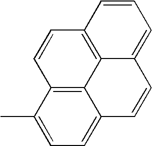 |
| 65 | H | H | 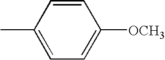 | 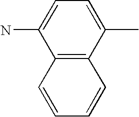 | H | 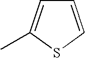 |
| 66 | H | H | 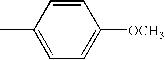 | 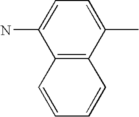 | H | 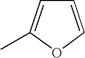 |
| 67 | H | H | 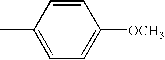 | 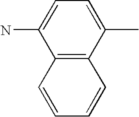 | —CH₃ | 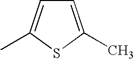 |
| 68 | H | H | 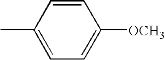 | 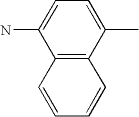 | —CH₃ | 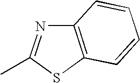 |
| 69 | H | H | 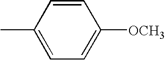 | 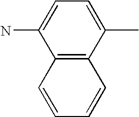 | —CH₃ | 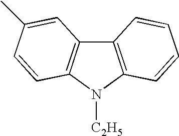 |
| 70 | H | H | 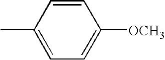 | 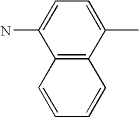 | 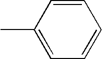 | 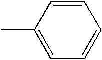 |

TABLE 1-11

| No. | b | c | 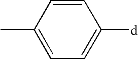 | 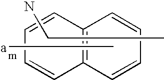 | Ar⁴ | Ar⁵ |
|---|---|---|---|---|---|---|
| 71 | H | H | 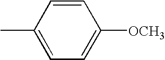 | 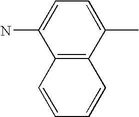 | 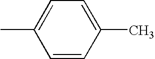 | 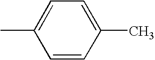 |
| 72 | H | H | 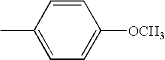 | 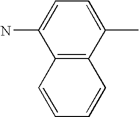 | 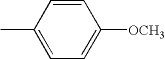 | 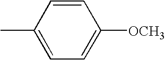 |
| 73 | H | H | 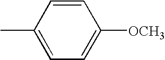 | 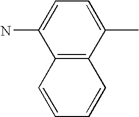 | 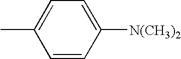 | 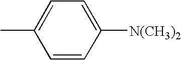 |
| 74 | H | H | 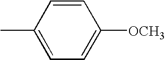 | 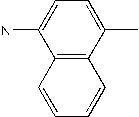 | 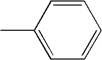 | 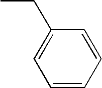 |
| 75 | H | H | 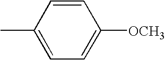 | 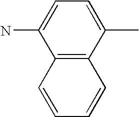 | 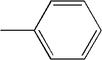 | 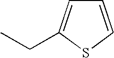 |

| | | | | | |
|---|---|---|---|---|---|
| 76 | H | H | 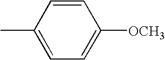 | 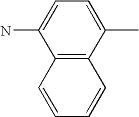 | 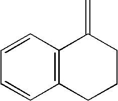 |
| 77 | H | H | 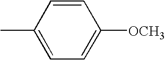 | 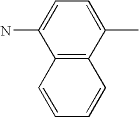 | 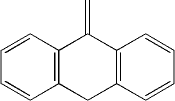 |

TABLE 1-12

| No. | b | c | 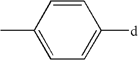 | 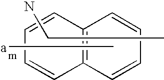 | Ar⁴ | Ar⁵ |
|---|---|---|---|---|---|---|
| 78 | H | H | 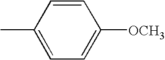 | 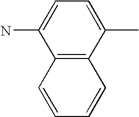 | 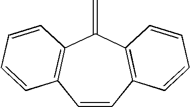 | |
| 79 | H | H | 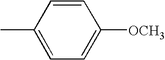 | 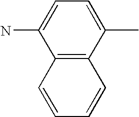 | 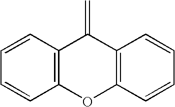 | |
| 80 | H | H | 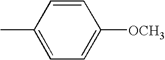 | 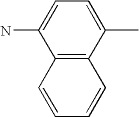 | 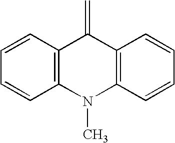 | |
| 81 | H | H | 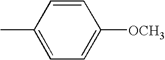 | 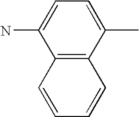 | H | 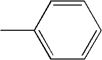 |
| 82 | H | H | 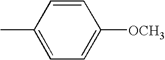 | 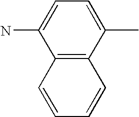 | H | 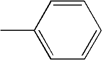 |
| 83 | H | H | 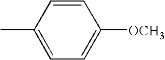 | 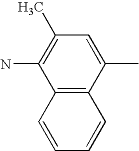 | H | 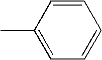 |
| 84 | H | H | 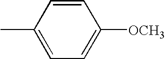 | 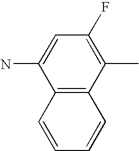 | H | 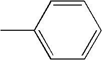 |

TABLE 1-13

| No. | b | c | 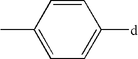 | 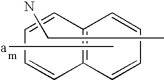 | Ar⁴ | Ar⁵ |
|---|---|---|---|---|---|---|
| 85 | H | H | 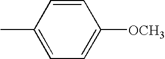 | 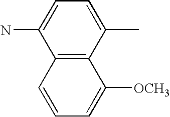 | H | 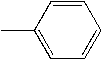 |
| 86 | H | H | 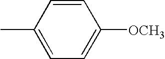 | 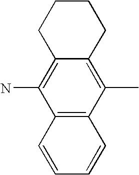 | H | 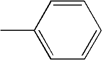 |
| 87 | H | H | 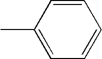 | 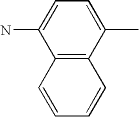 | H | 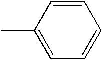 |
| 88 | H | H | 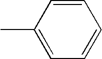 | 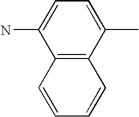 | —CH₃ | 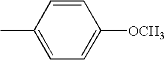 |
| 89 | H | H | 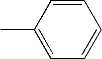 | 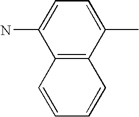 | 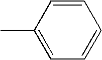 | 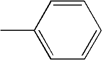 |
| 90 | H | H | 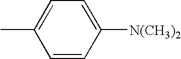 | 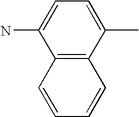 | H | 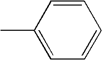 |
| 91 | H | H | 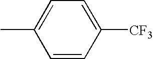 | 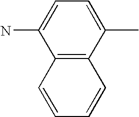 | H | 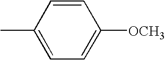 |

TABLE 1-14

| No. | b | c | 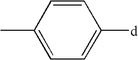 | 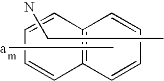 | Ar⁴ | Ar⁵ |
|---|---|---|---|---|---|---|
| 92 | H | H | 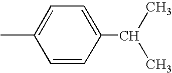 | 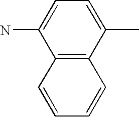 | 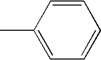 | 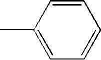 |
| 93 | H | H | 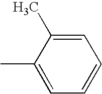 | 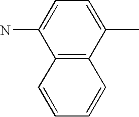 | H | 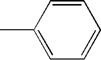 |
| 94 | H | H | 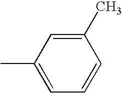 | 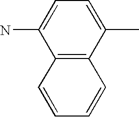 | H | 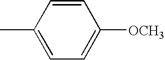 |
| 95 | H | H | 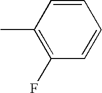 | 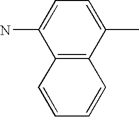 | 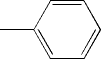 | 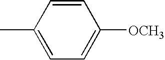 |
| 96 | H | H | 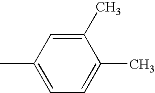 | 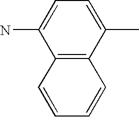 | H | 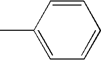 |
| 97 | H | H | 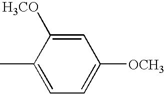 | 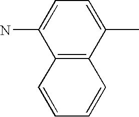 | —CH₃ | 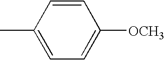 |
| 98 | H | H | 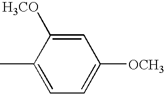 | 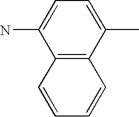 | 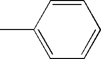 | 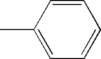 |

TABLE 1-15

| No. | b | c | 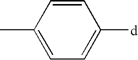 | 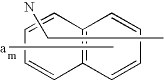 | Ar⁴ | Ar⁵ |
|---|---|---|---|---|---|---|
| 99 | H | H | 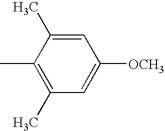 | 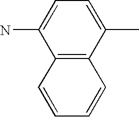 | H | 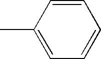 |
| 100 | H | H | 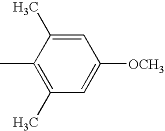 | 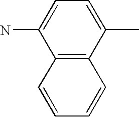 | H | 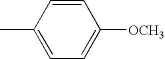 |
| 101 | H | H | 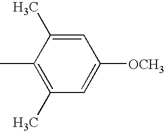 | 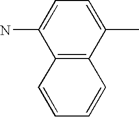 | 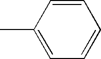 | 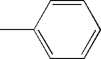 |
| 102 | H | H | 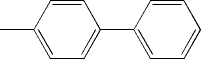 | 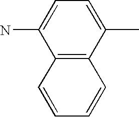 | H | 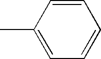 |
| 103 | H | H | 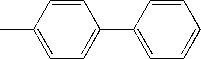 | 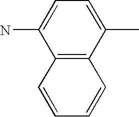 | —CH₃ | 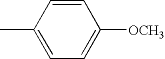 |
| 104 | H | H | 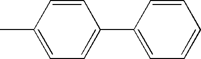 | 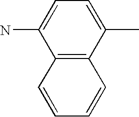 | 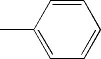 | 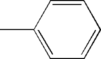 |
| 105 | H | H | 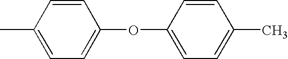 | 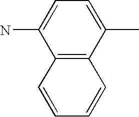 | H | 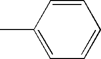 |

TABLE 1-16

| No. | b | c | 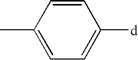 | 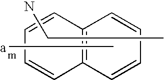 | Ar⁴ | Ar⁵ |
|---|---|---|---|---|---|---|
| 106 | H | H | 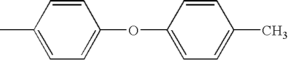 | 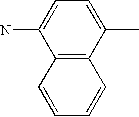 | H | 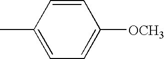 |
| 107 | H | H | 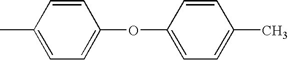 | 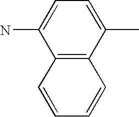 | —CH₃ | 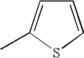 |
| 108 | H | H | 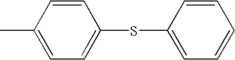 | 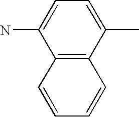 | H | 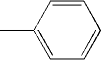 |
| 109 | H | H | 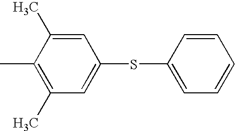 | 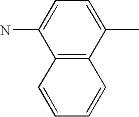 | —CH₃ | 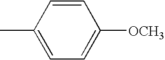 |
| 110 | H | H | 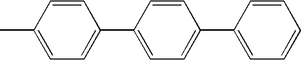 | 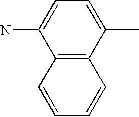 | —CH₃ | 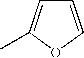 |
| 111 | H | H | 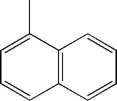 | 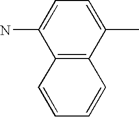 | H | 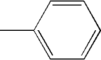 |
| 112 | H | H | 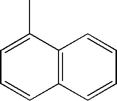 | 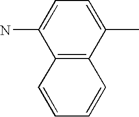 | —CH₃ | 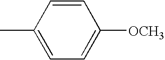 |

TABLE 1-17

| No. | b | c | 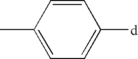 | 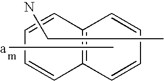 | Ar⁴ | Ar⁵ |
|---|---|---|---|---|---|---|
| 113 | H | H | 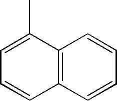 | 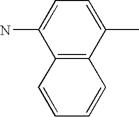 | H | 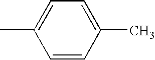 |
| 114 | H | H | 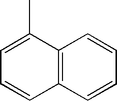 | 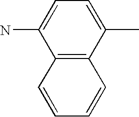 | —CH₃ | 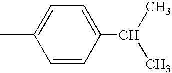 |
| 115 | H | H | 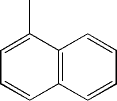 | 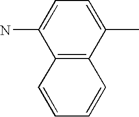 | H | 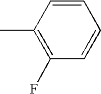 |
| 116 | H | H | 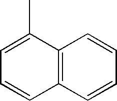 | 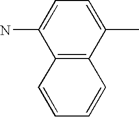 | —CH₃ | 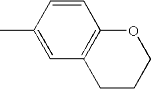 |
| 117 | H | H | 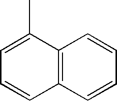 | 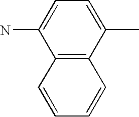 | —CH₃ | 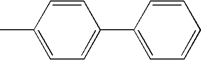 |
| 118 | H | H | 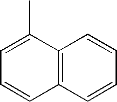 | 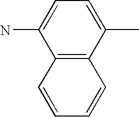 | —CH₃ | 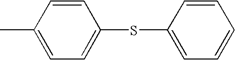 |
| 119 | H | H | 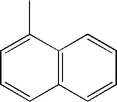 | 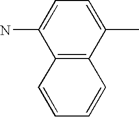 | H | 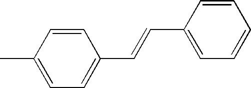 |

TABLE 1-18

| No. | b | c | 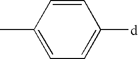 | 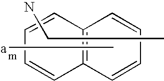 | Ar⁴ | Ar⁵ |
|---|---|---|---|---|---|---|
| 120 | H | H | 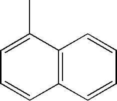 | 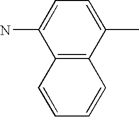 | —CH₃ | 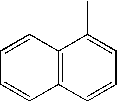 |
| 121 | H | H | 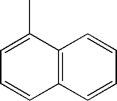 | 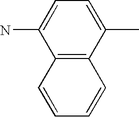 | —CH₃ | 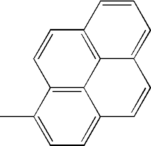 |
| 122 | H | H | 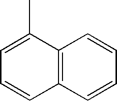 | 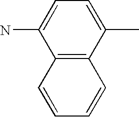 | —CH₃ | 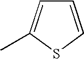 |
| 123 | H | H | 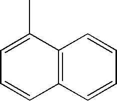 | 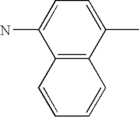 | H | 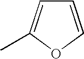 |
| 124 | H | H | 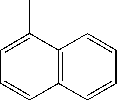 | 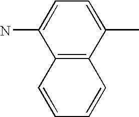 | 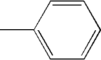 | 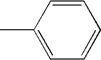 |
| 125 | H | H | 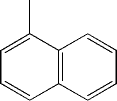 | 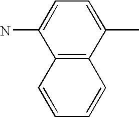 | 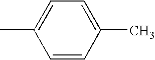 | 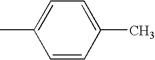 |
| 126 | H | H | 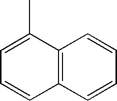 | 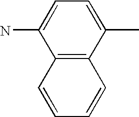 | 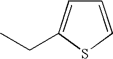 | 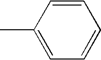 |

TABLE 1-19

| No. | b | c | 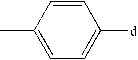 | 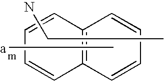 | Ar⁴ | Ar⁵ |
|---|---|---|---|---|---|---|
| 127 | H | H | 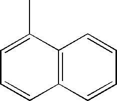 | 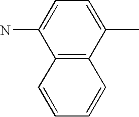 | 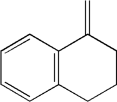 | |
| 128 | H | H | 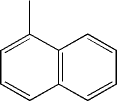 | 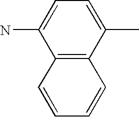 | 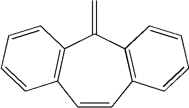 | |
| 129 | H | H | 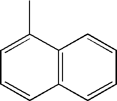 | 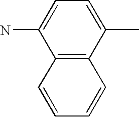 | 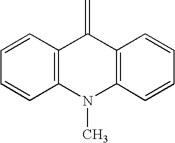 | |
| 130 | H | H | 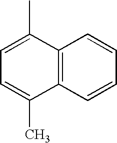 | 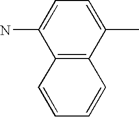 | H | 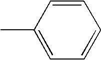 |
| 131 | H | H | 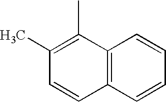 | 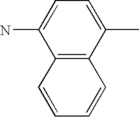 | H | 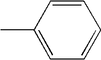 |
| 132 | H | H | 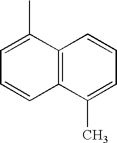 | 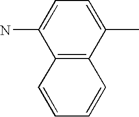 | H | 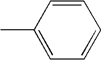 |
| 133 | H | H | 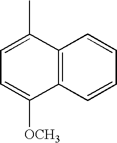 | 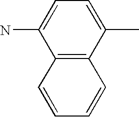 | H | 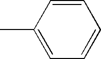 |

TABLE 1-20

| No. | b | c | 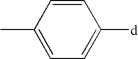 | 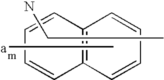 | Ar⁴ | Ar⁵ |
|---|---|---|---|---|---|---|
| 134 | H | H | 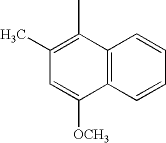 | 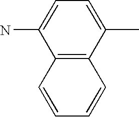 | H | 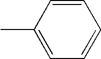 |
| 135 | H | H | 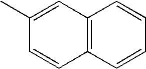 | 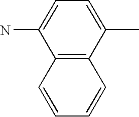 | H | 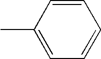 |
| 136 | H | H | 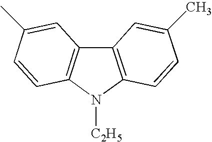 | 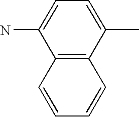 | 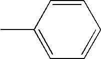 | 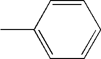 |
| 137 | H | H | 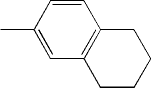 | 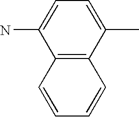 | H | 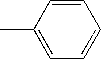 |
| 138 | p-CH₃ | p-CH₃ | 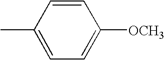 | 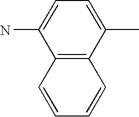 | H | 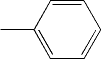 |
| 139 | p-OCH₃ | p-OCH₃ | 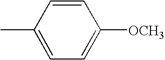 | 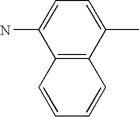 | H | 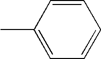 |
| 140 | o-F | o-F | 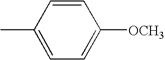 | 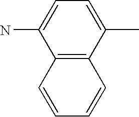 | H | 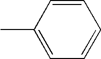 |

TABLE 1-21

| No. | b | c | 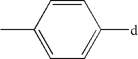 | 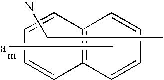 | Ar⁴ | Ar⁵ |
|---|---|---|---|---|---|---|
| 141 | 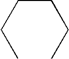 | 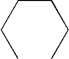 | 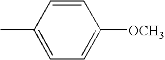 | 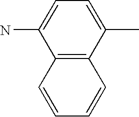 | H | 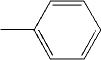 |
| 142 | p-OCH₃ | H | 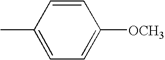 | 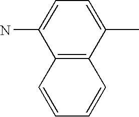 | H | 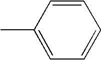 |
| 143 | 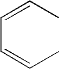 | 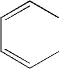 | 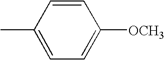 | 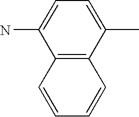 | H | 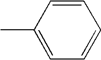 |

The electron transport material is represented by the formula (2).

The substituent in the formula (2) will be explained.

The alkyl group, alkoxy group and aryl group of R₁ to R₈ which may have a substituent have the same meanings as the substituent a in the formula (1).

Examples of the electron transport material represented by the formula (2) include the exemplified compounds a to e represented by, for example, the following structural formulae.

As the exemplified compound a, a compound substituted with a n-butoxycarbonyl group at the fourth position (R₈ in the formula (2) is a n-butyl group) is preferable.

As the exemplified compound b, a compound substituted with a phenethoxycarbonyl group at the fourth position (R₈ in the formula (2) is a phenethyl group) is preferable.

As the exemplified compound c, a compound substituted with a carbethoxy group at the fourth position (R₈ in the formula (2) is a 2-(2-ethoxyethoxy)ethyl group) is preferable.

As the exemplified compound d, a compound substituted with a n-butoxy carbonyl group and a nitro group at the fourth position and seventh position respectively (R₂ and R₈ in the formula (2) are a nitro group and a n-butyl group) is preferable.

Among these compounds, the exemplified compounds a, b and c having a substituent at the above substitution position are more preferable.

These compounds may be synthesized by the method described in Japanese Examined Patent Publication No. 4-48215.

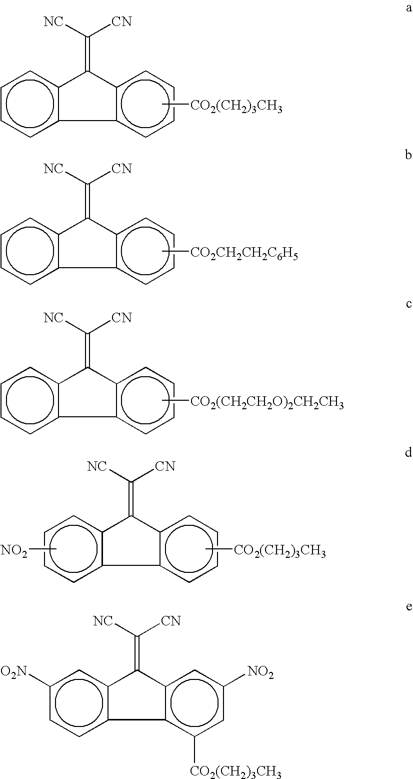

As the binder resin, resins which are used with the intention of improving the mechanical strength and durability of, for example, the monolayer type photosensitive layer, are used in the fields concerned and have binding ability may be used.

Specific examples of the binder resin include thermoplastic resins such as a polymethylmethacrylate, polystyrene, vinyl type resin such as a polyvinyl chloride, polycarbonate, polyester, polyester carbonate, polysulfone, polyarylate, polyamide, methacryl resin, acryl resin, polyether, polyacrylamide and polyphenylene oxide; thermosetting resins such as a phenoxy resin, epoxy resin, silicone resin, polyurethane, phenol resin, alkyd resin, melamine resin, phenoxy resin, polyvinylbutyral and polyvinylformal, partially crosslinked materials of these resins, copolymer resins containing two or more structural units contained in these resins (insulating resins such as a vinyl chloride/vinyl acetate copolymer resin, vinyl chloride/vinyl acetate/maleic acid anhydride copolymer resin and acrylonitrile/styrene copolymer resin). These binder resins may be used either singly or in combinations of two or more.

Among these resins, a polystyrene, polycarbonate, polyarylate and polyphenylene oxide are preferable because these materials have a volume resistance of 10¹³Ω or more, so that they have high electric insulating characteristics and are also superior in film-forming ability and potential characteristics, and a polycarbonate is particularly preferably used.

With regard to the ratio of the hole transport material to the electron transport material to be used, though no particular limitation is imposed on it, the ratio H/E of the weight H of the hole transport material to the weight E of the electron transport material is preferably 9/1 to 1/1.

When the ratio H/E exceeds 9/1, only the function of the hole transport material is exhibited and the charge transport complex does not exhibit its function. When the ratio H/E is less than 1/1, on the other hand, there is the case where the electron transport material which has not form the charge transport complex acts as a trap level, causing a reduction in sensitivity.

The content of the charge transport material is preferably 5 to 70% by weight based on the monolayer type photosensitive layer.

When the content of the charge transport material exceeds 70% by weight, there is the case where the film strength is reduced. When the content of the charge transport material is less than 5% by weight, on the other hand, no charge can be transferred, there is the case where a reduction in sensitivity is caused.

The content of the charge generation material is preferably 2 to 10% by weight based on the monolayer type photosensitive layer.

When the content of the charge generation material exceeds 10% by weight, not only the film strength of the photosensitive layer is reduced, but also the dispersibility of the charge generation material is reduced with an increase in coarse particles, so that surface charges on the part other than the part to be eliminated by exposure are reduced and there is therefore a fear as to the occurrence of image defects and particularly many image fogs called black dot which is the phenomenon that toners are stuck to the white background to form fine black spots. When the content of the charge generation material is less than 2% by weight, there is the case where the sensitivity of the monolayer type photoreceptor is deteriorated.

The content of the binder resin is preferably 30 to 80% by weight based on the monolayer type photosensitive layer.

When the ratio of the binder resin exceeds 80% by weight, there is the case where the function of the monolayer type photosensitive layer is deteriorated. When the content of the binder resin is less than 30% by weight on the other hand, there is a fear as to a reduction in the film strength of the monolayer type photosensitive layer.

The monolayer type photosensitive layer 140 may be formed in the following manner. Specifically, the charge generation material 12, the charge transport material 13 (hole transport material and electron transport material), the binder resin 17 and additives such as an antioxidant according to the need are dissolved or dispersed in a proper organic solvent to prepare a photosensitive layer forming coating solution. Then, the coating solution is applied to the surface of the conductive support 11 or on the surface of the intermediate layer 18 formed on the conductive support 1. Then, the support is dried to remove the organic solvent and thus, the monolayer type photosensitive layer can be formed. To describe in more detail, for example, the structural materials are dissolved or dispersed in a binder resin solution prepared by dissolving the binder resin in an organic solvent to prepare a monolayer type photosensitive layer forming coating solution.

The hole transport material and electron transport material of the present invention form a charge transport complex in the organic solvent.

Examples of the organic solvent include aromatic hydrocarbons such as benzene, toluene, xylene, mesitylene, tetralin, diphenylmethane, dimethoxybenzene and dichlorobenzene; hydrocarbon halides such as dichloromethane, dichloroethane and tetrachloropropane; ethers such as tetrahydrofuran (THF), dioxane, dibenzyl ether, dimethoxymethyl ether and 1,2-dimethoxyethane; ketones such as methyl ethyl ketone, cyclohexanone, acetophenone and isophrone; esters such as methyl benzoate, ethyl acetate and butyl acetate; sulfur-containing solvents such as diphenyl sulfide; fluorine type solvents such as hexafluoroisopropanol; and aprotic polar solvents such as N,N-dimethylformamide and N,N-dimethylacetamide. These compounds may be used either singly or in combinations of two or more. Also, mixed solvents obtained by adding alcohols, acetonitrile or methyl ethyl ketone to the above solvents may be used. Among these solvents, non-halogen type organic solvents are preferably used in consideration of the global atmosphere.

The charge generation material and other additives may be pre-milled prior to the process of dissolving or dispersing the structural materials in the resin solution.

The pre-milling may be carried out using a general milling machine, for example, a ball mill, sand mill, attritor, vibration mill or ultrasonic dispersing machine.

The dissolution or dispersion of the structural material in the resin solution may be carried out using a general dispersing machine such as a paint shaker, ball mill or sand mill. At this time, it is preferable to design proper dispersing conditions so as to prevent the occurrence of the phenomenon that impurities are generated by abrasion from the members constituting the container and dispersing machine and get mixed in the coating solution.

As the method of applying the monolayer type photosensitive layer forming coating solution, an appropriate method may be selected in consideration of the properties and productivity of the coating solution and specific examples of the method include roll coating, spray coating, blade coating, ring coating and dip coating.

Among these coating methods, the dip coating method is a method in which a substrate is dipped in a coating vessel filled with a coating solution and then, the substrate is pulled up at a constant rate or a gradually varied rate to form a layer on the surface of the substrate. This method is relatively simple and is superior in productivity and production cost. Therefore, the dip coating method is frequently utilized in the case of producing an electrophotographic photoreceptor. The device used in the dip coating method may be provided with a coating solution dispersing device typified by a ultrasonic generation device.

The monolayer type photosensitive layer may contain a charge transport material other than the hole transport material represented by the formula (1) and the electron transport material represented by the formula (2) to the extent that the effect of the present invention is not impaired with the view of improving the charge transport ability.

Specific examples of the charge transport material include enamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives and benzidine derivatives, polymers having groups derived from these compounds on the principal chain or side chain, for example, poly-N-vinylcarbazole and poly-1-vinylpyrene and poly-9-vinylanthracene.

The monolayer type photosensitive layer may contain various additives such as an antioxidant, ultraviolet absorber, plasticizer and leveling agent.

Examples of the antioxidant include a phenol type compound, hydroquinone type compound, tocopherol type compound, and amine type compound. Among these compounds, hindered phenol derivatives, hindered amine derivatives and mixtures of these derivatives are preferable.

The compounding of the antioxidant and ultraviolet absorber reduces the deterioration of the monolayer type photosensitive layer which is caused by oxidizing gases such as ozone and nitrogen oxides and also improves the stability of the coating solution.

The content of the antioxidant is preferably 0.1 to 50 parts by weight based on 100 parts by weight of the charge transport material. When the content of the antioxidant exceeds 50 parts by weight, there is the case where this exerts an adverse influence on the characteristics of the monolayer type photoreceptor. When the content of the antioxidant is less than 0.1 parts by weight on the other hand, there is the case where the effect of improving the stability of the coating solution and the durability of the monolayer type photoreceptor can be insufficiently obtained.

Examples of the plasticizer include dibasic acid ester such as a phthalate, fatty acid ester, phosphate, chlorinated paraffin and epoxy type plasticizers.

Examples of the leveling agent include silicone type leveling agents.

The film forming ability, flexibility and surface smoothness can be improved by compounding the plasticizer and the leveling agent.

The temperature in the drying step in the production of the monolayer type photosensitive layer is properly 50 to 140° C. and preferably 80 to 130° C., though no particular limitation is imposed on that temperature insofar as it is a temperature enough to remove the organic solvent to be used.

When the drying temperature exceeds 140° C., there is a fear that the electric characteristics of the monolayer type photoreceptor are deteriorated in repeated use, and therefore the obtained image deterionates. When the drying temperature is less than 50° C. on the other hand, there is the case where the drying time is prolonged.

The temperature condition in the production of the monolayer type photosensitive layer like this is common not only to the monolayer type photosensitive layer but also to the formation of layers such as an intermediate layer and to other treatments which will be explained later.

The film thickness of the monolayer type photosensitive layer is preferably 5 to 40 μm and more preferably 10 to 30 μm though no particular limitation is imposed on it.

When the film thickness of the monolayer type photosensitive layer exceeds 100 μm, there is a fear that the productivity of the monolayer type photoreceptor is reduced. When the film thickness of the monolayer type photosensitive layer is less than 5 μm, the charge retentive ability of the surface of the monolayer type photoreceptor is reduced and there is therefore a fear as to a reduction in the resolution of the monolayer type photosensitive layer.

### (Intermediate Layer 18)

The monolayer type photoreceptor of the present invention is preferably provided with an intermediate layer 18 between the conductive support 11 and the monolayer type photosensitive layer 140.

The intermediate layer has the ability to prevent the injection of charges into the monolayer type photosensitive layer or laminate type photosensitive layer from the conductive support. Specifically, the intermediate layer serves to suppress a reduction in the chargeability of the monolayer type photosensitive layer or laminate type photosensitive layer, to limit a reduction in surface charges on the part other than the part to be erased by exposure and to prevent the occurrence of image defects such as fogging. Particularly, the intermediate layer prevents the occurrence of image defects and particularly many image fogs called black dot which is the phenomenon that toners are stuck to the white background to form fine spots in the case of forming an image in the reverse developing process.

Also, the intermediate layer with which the surface of the conductive support is coated can reduce the degree of irregularities that are defects of the surface of the conductive support to uniform the surface, improves the film formation ability of the monolayer type photosensitive layer or laminate type photosensitive layer, and improves the adhesion between the conductive support and the monolayer type photosensitive layer or laminate type photosensitive layer.

The intermediate layer may be formed, for example, by dissolving a resin material in an appropriate solvent to prepare an intermediate layer forming coating solution and by applying this coating solution to the surface of the conductive support, followed by drying to remove the organic solvent.

Examples of the resin material include natural macromolecular materials such as casein, gelatin, polyvinyl alcohol and ethyl cellulose, besides the same binder resins that are contained in the monolayer type photosensitive layer. These resin materials may be used either singly or in combinations of two or more. Among these resins, polyamide resins are preferable and alcohol-soluble nylon resins are more preferable. Examples of the alcohol-soluble nylon resins include the so-called copolymer nylons obtained by copolymerizing, for example, 6-nylon, 6,6-nylon, 6,10-nylon, 11-nylon, 2-nylon or 12-nylon, and resins obtained by chemically modified nylon such as N-alkoxymethyl modified nylon and N-alkoxyethyl modified nylon.

Examples of the solvent used to dissolve or disperse the resin material include water, alcohols such as methanol, ethanol and butanol, grimes such as methyl carbitol and butyl carbitol, chlorine type solvents such as dichloroethane, chloroform or trichloroethane, acetone, dioxorane and mixed solvents obtained by blending two or more of these solvents. Among these solvents, non-halogen type organic solvents are preferably used in consideration of the global atmosphere.

Other steps and other conditions conform to those in the formation of the monolayer type photosensitive layer.

Also, the intermediate layer forming coating solution may contain metal oxide particles.

The metal oxide particles ensure that the volume resistance of the intermediate layer can be regulated with ease, the injection of charges into the monolayer type photosensitive layer or laminate type photosensitive layer can be more suppressed and also, the electric characteristics of the photoreceptor can be maintained in various circumstances.

Examples of the metal oxide particles include titanium oxide, aluminum oxide, aluminum hydroxide and tin oxide particles.

When the total weight of the binder resin and the metal oxide particles in the intermediate layer forming coating solution is C and the weight of the solvent is D, the ratio by weight of (C/D) is preferably 1/99 to 40/60 and more preferably 2/98 to 30/70.

Also, the ratio by weight (E/F) of the weight (E) of the resin material to the weight (F) of the metal oxide particles is preferably 90/10 to 1/99 and more preferably 70/30 to 5/95.

The film thickness of the intermediate layer is, though not particularly limited to, preferably 0.01 to 20 μm and more preferably 0.05 to 10 μm.

When the film thickness of the intermediate layer exceeds 20 μm, it is difficult to form a uniform intermediate layer and also, it is difficult to form a uniform monolayer type photosensitive layer on the intermediate layer, and there is a fear that the sensitivity of the monolayer type photoreceptor is deteriorated. When the film thickness of the intermediate layer is less than 0.01 μm, on the other hand, the resulting intermediate layer does not substantially play its role and there is a fear that it fails to obtain a uniform surface which is formed by coating the surface therewith. Specifically, the injection of charges from the conductive support into the monolayer type photosensitive layer cannot be prevented, causing a reduction in the charging ability of the monolayer type photosensitive layer.

When the structural material of the conductive support is aluminum, a layer containing alumite (alumite layer) may be formed as the intermediate layer.

An electrophotographic device according to the present invention is provided with the monolayer type photoreceptor of the present invention, a charge means that charges the above monolayer type photoreceptor, an exposure means that exposes the above charged photoreceptor with light and a developing means that develops the electrostatic latent image by exposure.

The electrophotographic device of the present invention will be explained with reference to the drawings. However, the electrophotographic device is not limited to the content of the following descriptions.

FIG. 3 is a schematic side view showing the structure of the electrophotographic device of the present invention.

An electrophotographic device (laser printer) 100 of FIG. 3 is provided with a monolayer type photoreceptor 1 (see FIG. 1), an exposure means (semiconductor laser) 31, a charge means (corona charger) 32, a developing means (developing unit) 33, a transfer device (transfer charger) 34, a conveying belt (not shown), a fixing means (fixing device) 35 and a cleaning means (cleaner) 36. No. 51 in the figure indicates a transport paper.

The photoreceptor 1 is supported by the body of the electrophotographic device 100 (not shown) in a rotatable manner and is rotated in the direction of the arrow 41 around a rotation axis 44 by a drive means (not shown). The drive means has, for example, a structure including an electric motor and a reduction gear and transmits its drive force to the conductive support constituting the core body of the monolayer type photoreceptor 1 to thereby rotate the monolayer type photoreceptor 1 at a specified peripheral velocity. The charger 32, the exposure means 31, the developing unit 33, the transfer charger 34 and the cleaner 36 are disposed in this order towards the down stream side from the upstream side in the direction of the rotation of the monolayer type photoreceptor 1 as shown by the arrow 41 along the outside periphery of the monolayer type photoreceptor 1.

The charger 32 is a charge means that charges the outside periphery of the monolayer type photoreceptor 1 to a specified potential.

The charge means in the electrophotographic device of the present invention is preferably a positively charged type from the viewpoint of reducing the generation of harmful ozone gas.

The exposure means 31 is provided with, for example, a semiconductor laser as the light source and applies light such as a laser beam emitted from the light source, to the surface of the monolayer type photoreceptor 1 at the position between the charger 32 and the developing unit 33 to expose the outside periphery of the charged monolayer type photoreceptor 1 to light corresponding to image information. The monolayer type photoreceptor 1 is scanned repeatedly by the light in the major scanning direction parallel to the rotation axis 44 of the monolayer type photoreceptor 1 and an image is formed along with this scanning operation, to form an electrostatic latent image gradually on the surface of the monolayer type photoreceptor 1. Namely, the amounts of charges on the surface of the monolayer type photoreceptor 1 uniformly charged by the charger 32 are made to be different between the part irradiated with the laser beam and the part non-irradiated with the laser beam, whereby an electrostatic latent image is formed.

The developing unit 33 is a developing means that develops the electrostatic latent image formed on the surface of the monolayer type photoreceptor 1 by a developer (toner). The developing unit 33 is disposed facing the monolayer type photoreceptor 1 and provided with a developing roller 33a that supplies a toner to the outside peripheral surface of the monolayer type photoreceptor 1 and a casing 33b that supports the developing roller 33a in such a manner as to be rotatable around the rotating axis parallel to the rotating axis 44 of the monolayer type photoreceptor 1 and that stores a developer containing the toner in its inside space.

The transfer charger 34 is a transfer means that transfers the toner image which is a visible image formed on the outside peripheral surface of the monolayer type photoreceptor 1 by developing, to the transfer paper 51 which is a recording medium supplied between the monolayer type photoreceptor 1 and the transfer charger 34 from the direction of the arrow 42 by a conveying means (not shown). The transfer charger 34 is, for example, a non-contact type transfer means that is provided with, for example, a charge means and provides charges having inverse polarity with respect to the toner to the transfer paper 51 to thereby transfer the toner image to the toner paper 51.

The cleaner 36 is a cleaning means that removes and recovers the toner remaining on the outside peripheral surface of the monolayer type photoreceptor 1 after the transfer operation using the transfer charger 34. The cleaner 36 is provided with a cleaning blade 36a that peels the toner left on the outside peripheral surface of the monolayer type photoreceptor 1 and a recovery casing 36b storing the toner peeled by the cleaning blade 36a. Also, this cleaner 36 is disposed together with a charge-removing lamp (not shown).

Also, the electrophotographic device 100 is provided with a fixing device 35 which is a fixing means that fixes the transferred image on the downstream side toward which the transfer paper 51 made to pass between the monolayer type photoreceptor 1 and the transfer charger 34 is conveyed. The fixing device 35 is provided with a heating roller 35a provided with a heating means (not shown) and a pressure roller 35b that is disposed facing the heating roller 35a and pressed by the heating roller 35a to form the contact part.

Also, the symbol 37 indicates a separating means that separates the transfer paper from the monolayer type photoreceptor and the symbol 38 indicates a casing storing various means used in the method of forming an image.

The image formation action of this electrophotographic device 100 is made as follows. First, when the monolayer type photoreceptor 1 is rotated in the direction of the arrow 41 by a drive means, the surface of the monolayer type photoreceptor 1 is positively or negatively charged uniformly to a prescribed potential by the charger 32 disposed on the upstream side of the imaging point of the light of the exposure means 31 in the direction of the rotation of the monolayer type photoreceptor 1.

Then, the surface of the monolayer type photoreceptor 1 is irradiated with the light emitted from the exposure means 32 corresponding to image information. In the monolayer type photoreceptor 1, the surface charge on the parts irradiated with the light is removed, which causes a difference in surface potential between the part irradiated with the light and the part which is not irradiated with the light, resulting in the formation of an electrostatic latent image.

The toner is supplied to the surface of the monolayer type photoreceptor 1 from the developing unit 33 disposed on the downstream side of the imaging point of the light of the exposure means 32 in the direction of the rotation of the monolayer type photoreceptor 1, to develop the electrostatic latent image, thereby forming a toner image.

The transfer paper 51 is fed between the monolayer type photoreceptor 1 and the transfer charger 34 synchronously with the exposure for the monolayer type photoreceptor 1. Charges having polarity opposite to that of the toner are provided to the fed transfer paper 51 to transfer the toner image formed on the surface of the monolayer type photoreceptor 1 to the surface of the transfer paper 51.

The transfer paper 51 with the image transferred thereto is conveyed to the fixing device 35 by a conveying means, and heated and pressurized when it is made to pass through the contact part between the heating roller 35a and the pressure roller 35b to fix the toner image to the transfer paper 51, thereby forming a fast image. The transfer paper 51 on which an image is thus formed is discharged out of the electrophotographic device 100 by a conveying means.

The toner left on the surface of the monolayer type photoreceptor 1 after the toner image is transferred by the transfer charger 34 is peeled from the surface of the monolayer type photoreceptor 1 by the cleaner 36 and recovered. The charges on the surface of the monolayer type photoreceptor 1 from which the toner is removed in this manner is removed by light emitted from a charge-removing lamp, so that the electrostatic latent image on the surface of the monolayer type photoreceptor 1 disappears. Thereafter, the monolayer type photoreceptor 1 is further rotated and then, a series of operations beginning with the charging operation are again repeated to form images continuously.

### EXAMPLES

The present invention will be explained in detail by way of examples and comparative examples, which are, however, intended to be limiting of the present invention.

### Example 1

9 parts by weight of titanium oxide (trade name: Tipaque TTO-D-1, manufactured by Ishihara Sangyo Kaisha Ltd.) and 9 parts by weight of a copolymer nylon resin (trade name: Amilan CM8000, manufactured by Toray Industries, Inc.) were added to a mixed solvent of 41 parts by weight of 1,3-dioxorane and 41 parts by weight of methanol and the mixture was dispersed by a paint shaker for 12 hours to prepare an intermediate layer coating solution.

The obtained intermediate layer coating solution was applied to the surface of an aluminum cylindrical support having a diameter of 30 mm and a length of 340 mm in a film thickness of 1 μm by a dipping coating method to form an intermediate layer.

Then, 215 parts by weight of oxotitanium phthalocyanine having the following structure as a charge generation material and 215 parts by weight of a polycarbonate resin (trade name: PCZ-400, manufactured by Mitsubishi Gas Chemical Company, Inc.) were added to 3310 parts by weight of tetrahydrofuran and the mixture was dispersed using a ball mill for 27 hours to prepare a charge generation material dispersion solution.

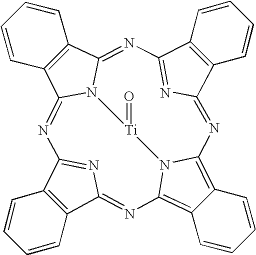

On the other hand, 122 parts by weight of the exemplified compound 1 as a hole transport material and 81 parts by weight of the exemplified compound a (synthesized according to the method described in the publication of Japanese Examined Patent Publication No. 4-48215) substituted with a n-butoxycarbonyl group at the fourth position as an electron transport material and 186 parts by weight of a polycarbonate resin (trade name: PCZ-400, manufactured by Mitsubishi Gas Chemical Company Inc.) as a binder resin were added to and dissolved in 1095 parts by weight of tetrahydrofuran to prepare a charge transport material solution. In the preparation, the solution was colored in a dark green tint and the formation of a charge transport complex was therefore confirmed.

175 parts by weight of the charge generation material dispersion solution was mixed in the total amount of the charge transport material solution with stirring to prepare a monolayer type photosensitive layer coating solution.

The obtained monolayer type photosensitive layer coating solution was applied to the surface of the intermediate layer by a dipping coating method and then the obtained coating film was dried using 110° C. hot air for 60 minutes to manufacture a monolayer type photoreceptor of FIG. 2 which had a monolayer type photosensitive layer 27 μm in film thickness.

### Example 2

A monolayer type photoreceptor of FIG. 2 was produced in the same manner as in Example 1 except that the exemplified compound 3 was used in place of the exemplified compound 1 as the hole transport material.

### Example 3

A monolayer type photoreceptor of FIG. 2 was produced in the same manner as in Example 1 except that the exemplified compound 6 was used in place of the exemplified compound 1 as the hole transport material.

### Example 4

A monolayer type photoreceptor of FIG. 2 was produced in the same manner as in Example 1 except that the exemplified compound III was used in place of the exemplified compound 1 as the hole transport material.

### Example 5

A monolayer type photoreceptor of FIG. 2 was produced in the same manner as in Example 1 except that the exemplified compound b (synthesized by the method described in the publication of Japanese Examined Patent Publication No. 4-48215) substituted with a phenethoxycarbonyl group at its fourth position was used in place of the exemplified compound a as the electron transport material.

### Example 6

A monolayer type photoreceptor of FIG. 2 was produced in the same manner as in Example 1 except that the exemplified compound c (synthesized by the method described in the publication of Japanese Examined Patent Publication No. 4-48215) substituted with a carbithoxy group at its fourth position was used in place of the exemplified compound a as the electron transport material.

### Example 7

A monolayer type photoreceptor of FIG. 1 was produced in the same manner as in Example 1 except that no intermediate layer was formed.

### Example 8

A monolayer type photoreceptor of FIG. 2 was produced in the same manner as in Example 1 except that an azo pigment having the following structure was used in place of oxotitanium phthalocyanine as the charge generation material.

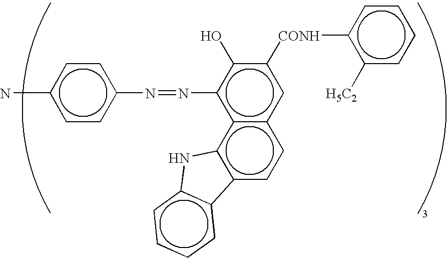

### Example 9

A monolayer type photoreceptor of FIG. 2 was produced in the same manner as in Example 1 except that 4 parts by weight of a hindered phenol type additive (trade name: Irganox (trademark) 1010, manufactured by Ciba Specialty Chemicals k.k.) was added as the antioxidant to the monolayer type photoreceptor coating solution.

### Comparative Example 1

A monolayer type photoreceptor of FIG. 2 was produced in the same manner as in Example 1 except that a triphenylamine dimer compound (TPD) having the following structure was used in place of the exemplified compound 1 as the hole transport material.

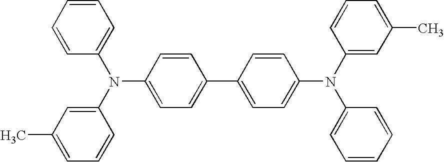

### Comparative Example 2

A monolayer type photoreceptor of FIG. 2 was produced in the same manner as in Example 1 except that an enamine compound (ENA) having the following structure was used in place of the exemplified compound 1 as the hole transport material.

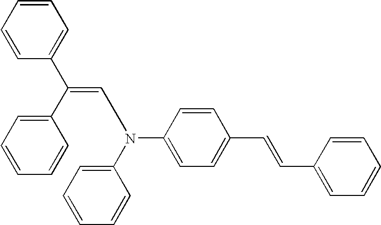

### Comparative Example 3

A monolayer type photoreceptor of FIG. 2 was produced in the same manner as in Example 1 except that 3,5-dimethyl-3′,5′-di-t-butyldiphenoquinone compound (DQ) having the following structure was used in place of the exemplified compound a as the electron transport material. When the charge transport material solution was prepared, the color of the solution was not changed and therefore, the formation of the charge transport complex was not confirmed.

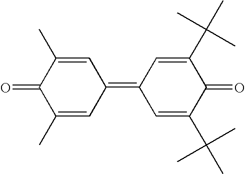

### (Evaluation Using an Actual Machine)

Each photoreceptor obtained in Examples 1 to 9 and Comparative Examples 1 to 3 was set to a test copying machine which was prepared by remodeling a negatively charged system digital copying machine (trade name: AR-450, manufactured by Sharp Kabushiki Kaisha) into a positively charged system digital copying machine to form an image 50,000 times, to make evaluation tests concerning sensitivity, printing durability and the formation of a charge transport complex.

### (Evaluation of Electric Characteristics)

The developing unit was dismounted from the test copying machine and a surface potentiometer (model 344, manufactured by Trek Japan) was set to the developing part instead. Using this copying machine, it was placed in the normal temperature/normal humidity (N/N) circumstance kept at 25° C. under a relative humidity of 50% to adjust the surface potential of the photoreceptor to +650 V when no exposure using laser light was not carried out and in this condition, the photoreceptor was exposed to laser light (0.4 μJ/cm²) to measure the surface potential of the photoreceptor as exposure potential VL (V). The smaller the exposure potential VL was, the higher the sensitivity was evaluated to be, to rate the photoreceptor according to the following standard.

### <Criterion>

◯: Excellent (|VL|<120 (V)

Δ: Good (120 (V)≦|VL|<150 (V)

X: Inferior (150 (V)≦|VL|)

### (Printing Durability)

The pressure, the so-called cleaning blade pressure, of the cleaning blade at the position where the cleaning blade of the cleaning device installed in the test copying machine was in contact with the monolayer type photoreceptor was adjusted to 20 gf/cm (1.96×10⁻¹ N/cm) in terms of initial line pressure. Each photoreceptor was subjected to a printing durability test carried out in the N/N circumstance, in which test, a character test chart was formed on 50,000 sheets.

The film thickness, that is, the layer thickness of the photosensitive layer was measured by using a film thickness measuring device (trade name: F-20-EXR, manufactured by Filmetrics) when the printing durability test was started and after an image was formed on 50,000 sheets. From a difference between the film thickness measured when the printing durability test was started and the film thickness measured after an image was formed on 50,000 sheets, the amount of the abrasion of the photosensitive layer per 50,000 rotations of the photoreceptor drum was found. The larger the amount of abrasion was, the more inferior the printing durability was evaluated to be, to rate the photoreceptor according to the following standard.

### <Criterion>

◯: Excellent (Amount of abrasion d<0.8 μm/50 k rotations

Δ: Good (0.8 μm/50 k rotations≦Amount of abrasion d<1.0 μm/50 k rotations

X: Inferior (1.0 μm/50 k rotations≦Amount of abrasion d

### (Evaluation of the Formation of a Charge Transport Complex)

When the charge generation material dispersion solution was mixed with the charge transport material solution to prepare a monolayer type photosensitive layer coating solution, the case where the coating solution was colored in a dark green tint was determined to show the formation of a charge transport complex and rated as “◯”, whereas the case where the coating solution was not colored in a dark green tint was determined to show no formation of a charge transport complex and rated as “X”.

The above results of evaluation are shown in Table 2 together with the major structural components of the monolayer type photosensitive layer.

TABLE 2

| | | Charge | | | | | | | | |
|---|---|---|---|---|---|---|---|---|---|---|
| | | Transport | | | | | | | | |
| | | Material | | | | Sensitivity | | | | |
| | Charge | Hole | Electron | | Charge | (VL) | | Stability | Reduction in Film | |
| | Generation | Transport | Transport | | Transport | | After | in | Amount | |
| | Material | Material | Material | Remark | Complex | Initial | Printing | Sensitivity | (μm) | Determination |
| Example 1 | phthalocyanine | 1 | a | | ◯ | 95 | 115 | ◯ | 0.71 | ◯ |
| Example 2 | phthalocyanine | 3 | a | | ◯ | 85 | 105 | ◯ | 0.74 | ◯ |
| Example 3 | phthalocyanine | 6 | a | | ◯ | 90 | 115 | ◯ | 0.75 | ◯ |
| Example 4 | phthalocyanine | 111 | a | | ◯ | 95 | 110 | ◯ | 0.71 | ◯ |
| Example 5 | phthalocyanine | 1 | b | | ◯ | 95 | 115 | ◯ | 0.75 | ◯ |
| Example 6 | phthalocyanine | 1 | c | | ◯ | 100 | 115 | ◯ | 0.74 | ◯ |
| Example 7 | phthalocyanine | 1 | a | no | ◯ | 90 | 120 | Δ | 0.75 | ◯ |
| | | | | Intermediate | | | | | | |
| | | | | Layer | | | | | | |
| Example 8 | azo | 1 | a | | ◯ | 110 | 140 | Δ | 0.72 | ◯ |
| Example 9 | phthalocyanine | 1 | a | including | ◯ | 100 | 110 | ◯ | 0.75 | ◯ |
| | | | | additive | | | | | | |
| Comparative | phthalocyanine | TPD | a | | ◯ | 105 | 145 | Δ | 1.5 | X |
| Example 1 | | | | | | | | | | |
| Comparative | phthalocyanine | ENA | a | | ◯ | 90 | 115 | ◯ | 1.35 | X |
| Example 2 | | | | | | | | | | |
| Comparative | phthalocyanine | 1 | DQ | | X | 95 | 200 | X | 0.73 | ◯ |
| Example 3 | | | | | | | | | | |

From a comparison between Example 1 and Comparative Example 3, it is found that the formation of a charge transport complex contributes to an improvement in electric characteristics. However, from the results of Comparative Examples 1 and 2, it is found that an improvement in electric characteristics is not made only by the formation of a charge transport complex.

Though the details of this mechanism are not clarified, it is inferred that in the monolayer type photoreceptor provided with the monolayer type photosensitive layer containing a charge transport material constituted of a combination of a specified hole transport material and a specified electron transport material according to the present invention, a charge transport complex forms an intermediate level to make smooth the transfer of charges to the charge transport material from the charge generation material.

Also, from a comparison between Examples 1 to 9 and Comparative Example 2, it is found that though the electric characteristics of the photoreceptor are improved by the formation of a specific charge transport complex, the monolayer type photoreceptor obtained in Comparative Example 2 still has the problem concerning abrasive resistance whereas each monolayer type photoreceptor obtained in Examples 1 to 9 is improved in abrasive resistance (printing durability) and exhibits very good printing durability since a reduction in the average thickness of the drum film when an image is actually printed 50,000 times is 1 μm/50 k rotations or less.

Though the details of this mechanism are not clarified, it is inferred that in the monolayer type photoreceptor of the present invention, the charge transport complex contributes to an improvement in abrasive resistance (printing durability).

From a comparison between Example 1 and Example 7, the blocking effect of the intermediate layer can be confirmed. The monolayer type photoreceptor of Example 7 provided no intermediate layer is slightly deteriorated in image though it has no problem in practical use and it is therefore found that it is inferior to the monolayer type photoreceptor of Example 1.

From the results of Example 9, it is found that the electric characteristics of the monolayer type photoreceptor can be stabilized by the addition of a hindered phenol type additive as an antioxidant.

What is claimed is:

1. A monolayer type photoreceptor obtained by laminating a monolayer type photosensitive layer containing a charge generation material and a charge transport material on a conductive support, wherein the above monolayer type photosensitive layer comprises, as the above charge transport material;
a hole transport material represented by the following formula (1): 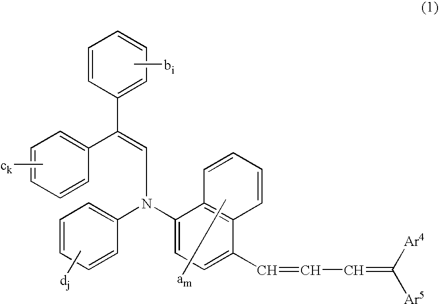
wherein:
“a” represents an alkyl group which may have a substituent, an alkoxy group which may have a substituent, a dialkylamino group which may have a substituent, an aryl group which may have a substituent, a halogen atom or a hydrogen atom;
m denotes an integer from 1 to 6, and when m is 2 or more, “a” may be the same or different and may be combined to form a cyclic structure;
b, c and d, which may be the same or different, respectively represent an alkyl group which may have a substituent, an alkoxy group which may have a substituent, a dialkylamino group which may have a substituent, an aryl group which may have a substituent, an aryloxy group which may have a substituent, an arylthio group which may have a substituent, a halogen atom or a hydrogen atom;
i, k and j, which may be the same or different, respectively denote an integer from 1 to 5, and when i is 2 or more, b may be the same or different and may be combined to form a cyclic structure, when k is 2 or more, c may be the same or different and may be combined to form a cyclic structure, and when j is 2 or more, d may be the same or different and may be combined to form a cyclic structure; and
Ar⁴ and Ar⁵, which may be the same or different, respectively represent an alkyl group which may have a substituent, an aryl group which may have a substituent, an arylalkyl group which may have a substituent, a heterocyclic group which may have a substituent or a hydrogen atom, provided that Ar⁴ and Ar⁵ are not hydrogen atoms at the same time and may be combined through an atom or atomic group to form a cyclic group; and
an electron transport material represented by the following formula (2): 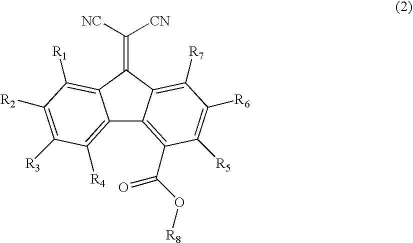
wherein R₁ to R₈, which may be the same or different, respectively represent an alkyl group which may have a substituent, an alkoxy group which may have a substituent, an aryl group which may have a substituent, a nitro group or a hydrogen atom.

2. The monolayer type photoreceptor of claim 1, wherein the hole transport material is selected from following compounds:

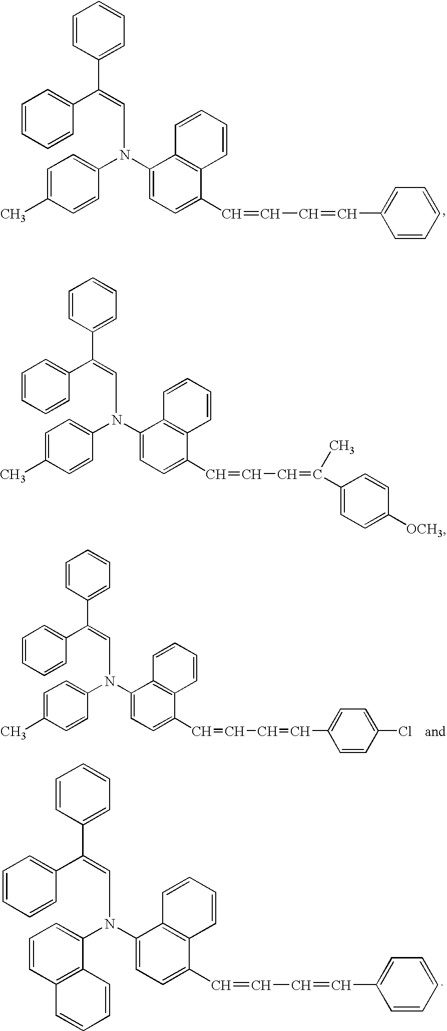

3. The monolayer type photoreceptor of claim 1, wherein the electron transport material is selected from following compounds:

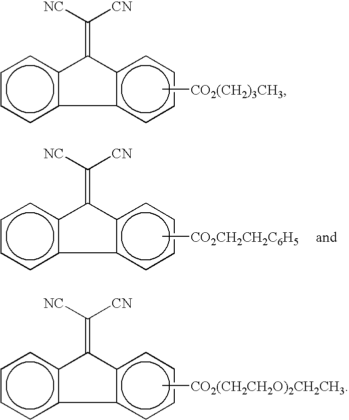

4. The monolayer type photoreceptor of claim 1, wherein the ratio H/E of the weight H of the hole transport material to the weight E of the electron transport material is 9/1 to 1/1.

5. The monolayer type photoreceptor of claim 1, wherein the content of the charge transport material is 5 to 70% by weight based on the monolayer type photosensitive layer.

6. The monolayer type photoreceptor of claim 1, wherein the content of the charge generation material is 2 to 10% by weight based on the monolayer type photosensitive layer.

7. The monolayer type photoreceptor of claim 1, wherein the charge generation material is at least one selected from azo type pigments, indigo type pigments, perylene type pigments, polycyclic quinone type pigments, phthalocyanine type pigments, squalilium dyes, pyrylium salts, thiopyrylium salts, triphenylmethane type dyes, selenium and amorphous silicon.

8. The monolayer type photoreceptor of claim 1, wherein the monolayer type photosensitive layer contains hindered phenol derivatives and/or hindered amine derivatives as an antioxidant.

9. The monolayer type photoreceptor of claim 1, wherein is provided with an intermediate layer between the conductive support and the monolayer type photosensitive layer.

10. An electrophotographic device comprising the monolayer type photoreceptor of claim 1, a charge means that charges the monolayer type photoreceptor, an exposure means that exposes the above charged monolayer type photoreceptor to light and a developing means that develops the electrostatic latent image formed by the exposure.

11. The electrophotographic device of claim 10, wherein the charge means is a positively charged type.
